(19) United States
(12) Patent Application Publication
(10) Pub. No.: US 2026/0172687 A1
(43) Pub. Date: Jun. 18, 2026

(54) INFORMATION PROCESSING APPARATUS, METHOD, AND STORAGE MEDIUM

(71) Applicant: CANON KABUSHIKI KAISHA, Tokyo (JP)

(72) Inventor: REINA YOSHIZAKI, Kanagawa (JP)

(21) Appl. No.: 19/394,083

(22) Filed: Nov. 19, 2025

(30) Foreign Application Priority Data
Dec. 13, 2024 (JP) 2024-218471

(51) Int. Cl. H04N 23/695; H04N 23/69

(52) U.S. Cl. CPC H04N 23/695; H04N 23/69

(57) ABSTRACT

A processing apparatus includes an acquisition unit configured to acquire a captured image from an imaging apparatus that can be driven to pan and tilt, a display control unit configured to perform control in such a manner as to display a first region for displaying transition information about a pan angle or a tilt angle of the imaging apparatus, a second region for displaying at least one or more of a transition speed of a pan angle and a transition speed of a tilt angle, and a third region for displaying the acquired captured image, an editing unit configured to edit information displayed in the first region and the second region, and a control unit configured to control a pan angle or tilt angle of the imaging apparatus.

### BACKGROUND

### Field of the Technology

The aspect of the embodiments relates to an information processing apparatus, a control method, and a storage medium.

### Description of the Related Art

In recent years, a network camera that can remotely control an imaging apparatus, and a control apparatus for video production have become common. The remote control of the imaging apparatus includes pan, tilt, and zoom operations, and a preset operation of pre-registering and invoking an image capturing position and settings. The remote control also includes a trace operation of recording execution details and execution timings of a series of camera operations in a predetermined period, as trace information, and executing the control of the imaging apparatus with reference to the trace information, and the like.

In a case where desired trace information fails to be recorded when trace information is recorded, operations including successful parts have been redone from the beginning. This point has been raised as an issue.

In view of the foregoing, Japanese Patent Laid-Open No. 2023-117195 describes a technique of correcting trace information by correcting a graph indicating a locus of an imaging apparatus that is based on trace information.

Nevertheless, in the method described in Japanese Patent Laid-Open No. 2023-117195, when the trace information is corrected, captured images to be acquired by corrected pan, tilt, and zoom positions cannot be checked.

### SUMMARY

A processing apparatus according to the aspect of the embodiments includes an acquisition unit configured to acquire a captured image from an imaging apparatus that can be driven to pan and tilt, a display control unit configured to perform control in such a manner as to display a first region for displaying transition information about a pan angle or a tilt angle of the imaging apparatus, a second region for displaying at least one or more of a transition speed of a pan angle and a transition speed of a tilt angle, and a third region for displaying the acquired captured image, an editing unit configured to edit information displayed in the first region and the second region, and a control unit configured to control a pan angle or tilt angle of the imaging apparatus, in which the control unit performs control in such a manner as to drive the imaging apparatus to a pan angle or a tilt angle designated by a user, in the first region or the second region.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration according to a first embodiment.

FIG. 2 is a diagram illustrating hardware configurations of an imaging apparatus and an information processing apparatus according to the first embodiment.

FIG. 3 is a diagram illustrating functional blocks of the information processing apparatus according to the first embodiment.

FIG. 4 is a diagram illustrating an example of a graphical user interface (GUI) according to the first embodiment.

FIG. 5 is a diagram illustrating an example of trace information according to the first embodiment.

FIG. 6 is a flowchart illustrating a flow of control according to the first embodiment.

FIG. 7 is a diagram illustrating an example of a GUI according to the first embodiment.

FIG. 8 is a diagram illustrating an example of a GUI to be displayed when trace information is edited according to the first embodiment.

FIG. 9 is a diagram illustrating an example of a graph of a locus line according to the first embodiment.

FIG. 10 is a flowchart illustrating a flow of control according to a second embodiment.

FIG. 11 is a diagram illustrating an example of trace information according to the second embodiment.

FIG. 12 is a diagram illustrating an example of a GUI according to a third embodiment.

FIG. 13 is a flowchart illustrating a flow of control according to the third embodiment.

FIG. 14 is a flowchart illustrating a flow of control according to the third embodiment.

FIG. 15 is a flowchart illustrating a flow of control according to a fourth embodiment control.

FIG. 16 is a diagram illustrating an example of a GUI according to the fourth embodiment.

### DESCRIPTION OF THE EMBODIMENTS

Hereinafter, embodiments will be described in detail with reference to the accompanying drawings. The following embodiments are not intended to limit the disclosure set forth in the appended claims. Although a plurality of features is described in the embodiments, not all of the plurality of features is always essential to the disclosure, and the plurality of features may be arbitrarily combined. Furthermore, in the accompanying drawings, the same or similar configurations are assigned the same reference numerals, and the redundant description will be omitted.

### First Embodiment

### <System Configuration>

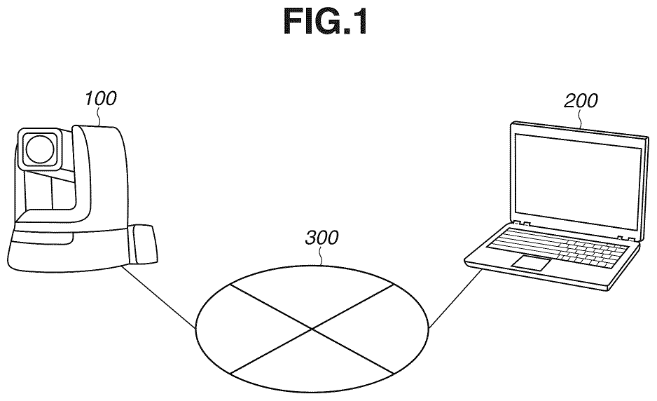

FIG. 1 is a diagram illustrating a configuration example of an imaging system including a control apparatus according to the embodiment. The imaging system according to the first embodiment includes an imaging apparatus 100 and an information processing apparatus 200.

The imaging apparatus 100 and the information processing apparatus 200 are connected to each other via a network 300. A method of connection between the apparatuses is not limited to a specific method. For example, the apparatuses may be connected via a cable.

The imaging apparatus 100 transmits image data that is based on an image capturing result, and various types of information about the imaging apparatus 100 to the information processing apparatus 200 via the network 300 as a signal. Here, for the sake of explanatory convenience, the information processing apparatus 200 is assumed to be connected to the imaging apparatus 100, but the number of imaging apparatuses to be connected is not limited, and it is sufficient that one or more imaging apparatuses are connected.

A signal to be input to the information processing apparatus 200 is not always input from the directly-connected imaging apparatus 100, and a signal can also be input via another processing apparatus such as a switcher or an effector.

In addition, the information processing apparatus 200 can also perform invoking and deleting of preset functions, and an advanced setting operation of an automatic loop function.

In addition, the description will be given assuming that the information processing apparatus 200 is integrated with hardware including an operation unit such as a camera controller that enables operations on a camera and an output image, but the information processing apparatus 200 may be independent as a separate apparatus.

In a case where the information processing apparatus 200 is independent of an operation unit, it is possible to set the positions of pan, tilt, and zoom (PTZ) drive units of the imaging apparatus 100, image qualities, and the like using a control apparatus such as a camera controller as the operation unit, and register these as preset values. In this case, a controller serving as an operation unit is connected to the imaging apparatus 100 via the network 300, or connected using serial connection or the like.

The network 300 is a network that connects the imaging apparatus 100 and the information processing apparatus 200. The network 300 is implemented by a plurality of routers, switches, cables, and the like that comply with a communication standard such as Ethernet (registered trademark), for example. Alternatively, the network 300 may be implemented by the internet, a wired local area network (LAN), a wireless LAN, a wide area network (WAN), or the like.

### <Hardware Configuration of Imaging Apparatus>

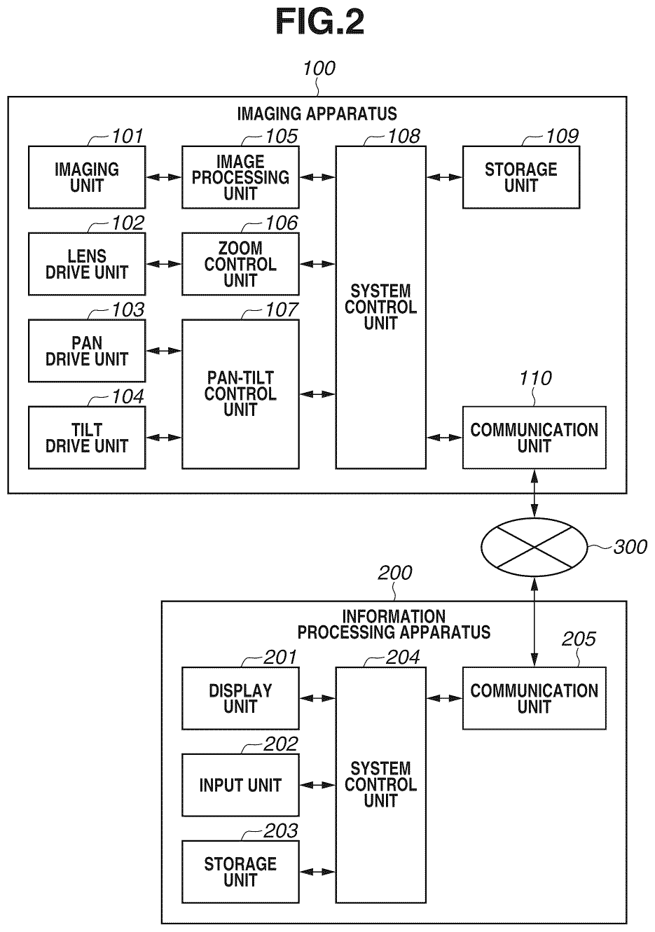

Next, the imaging apparatus 100 according to the embodiment will be described with reference to FIG. 2. FIG. 2 is a diagram illustrating an example of a hardware configuration of the imaging apparatus 100. The imaging apparatus 100 includes an imaging unit 101, a lens drive unit 102, a pan drive unit 103, a tilt drive unit 104, an image processing unit 105, a zoom control unit 106, and a pan-tilt control unit 107. The imaging apparatus 100 further includes a system control unit 108, a storage unit 109, and a communication unit 110, and the components are connected via an internal bus (not illustrated) in such a manner that communication can be performed with each other.

Programs for implementing functions according to the embodiment, and data to be used when the programs are executed are stored in a read-only memory (ROM) included in the storage unit 109, for example. Furthermore, under the control performed by the system control unit 108, these programs and data are imported into the RAM included in the storage unit 109, for example, and executed by the system control unit 108.

The imaging unit 101 performs the image capturing of a subject, and conversion into an electric signal. Specifically, the imaging unit 101 includes an image capturing optical system and an image sensor. The image capturing optical system is a lens that condenses light from the subject to an imaging plane of an image sensor, and includes, for example, a zoom lens, a focus lens, an image stabilization lens, and the like. The image sensor captures a subject image that has entered via the image capturing optical system, and converts the subject image into an electric signal. The image sensor is implemented by a charge-coupled device (CCD) sensor or a complementary metal-oxide semiconductor (CMOS) sensor, for example. A part of the image capturing optical system functions also as the lens drive unit 102 to be described below. In addition, it is possible to perform the adjustment of an exposure degree by changing a shutter speed and a gain of the image sensor.

The lens drive unit 102 includes a drive system of the focus lens and the zoom lens, and its operation is controlled by the zoom control unit 106. In addition, the lens drive unit 102 drives the zoom lens and the focus lens in accordance with a control command acquired via the zoom control unit 106 from the system control unit 108 to be described below. By driving the zoom lens and the focus lens, it is possible to change a zoom value and a focus value. Furthermore, the lens drive unit 102 outputs information regarding a zoom value and a focus value, to the zoom control unit 106. A zoom value and a focus value to be output may be output as values such as a zoom magnification and a focal length, or as a focus position.

The pan drive unit 103 includes a mechanical drive system that performs a pan operation, and a motor of a drive source, and its operation is controlled by the pan-tilt control unit 107. The pan drive unit 103 includes, for example, an actuator such as a stepping motor, and an encoder that detects a pan angle. The pan drive unit 103 can transmit the detected pan angle (pan value) to the pan-tilt control unit 107.

The tilt drive unit 104 includes a mechanical drive system that performs a tilt operation, and a motor of a drive source, and its operation is controlled by the pan-tilt control unit 107. The tilt drive unit 104 includes, for example, an actuator such as a stepping motor, and an encoder that detects a tilt angle. The tilt drive unit 104 can transmit the detected tilt angle (tilt value) to the pan-tilt control unit 107.

The image processing unit 105 generates image data by performing predetermined image processing and compression coding processing on signals obtained by image capturing and photoelectric conversion in the imaging unit 101. The number of pieces of image data to be generated is not limited to one, and the image processing unit 105 can simultaneously generate a plurality of pieces of image data with different resolutions and image qualities. In addition, the image processing unit 105 outputs the generated image data to the system control unit 108.

The zoom control unit 106 controls the lens drive unit 102 based on a control command acquired from the system control unit 108.

The pan-tilt control unit 107 controls the pan drive unit 103 and the tilt drive unit 104 based on a control command acquired from the system control unit 108.

The system control unit 108 is an example of a processor represented by a central processing unit (CPU) that comprehensively controls the entire imaging apparatus 100. In the embodiment, the system control unit 108 analyzes a control command acquired via the communication unit 110, and performs processing in accordance with the control command. Specifically, the system control unit 108 outputs a control command of image quality adjustment to the image processing unit 105, outputs control commands of zoom control and focus control to the zoom control unit 106, and outputs control commands of pan and tilt operations to the pan-tilt control unit 107. In addition, the system control unit 108 controls the control commands output to the zoom control unit 106 and the pan-tilt control unit 107, to be stored into the storage unit 109. At this time, in one embodiment, the system control unit 108 controls the output control commands to be stored into the storage unit 109 in association with time information, but the control is not limited to this. For example, only the control commands may be stored.

Furthermore, the system control unit 108 acquires image data generated by the image processing unit 105, and transmits the acquired image data to the communication unit 110. In addition, the system control unit 108 stores control commands acquired when trace information (transition information) to be described below is created and edited, into the storage unit 109 in association with time information (target reach time). In the embodiment, the system control unit 108 stores trace information, but the control is not limited to this. For example, a system control unit 204 to be described below may store control commands input by an input unit 202 when trace information is created and edited, into a storage unit 203 in association with time information. Here, the time information included in the trace information is information indicating a temporal transition of the position of each locus point. In addition, the target reach time is an elapsed time from the reproduction of a trace until angles reach designated pan and tilt angles.

The storage unit 109 stores image data, various setting commands, and the like. The storage unit 109 stores various computer programs and various types of data as information required when the system control unit 108 performs processing. That is, the storage unit 109 is a main storage memory, and is used as a work area and a temporary storage region for loading various programs. In addition, the storage unit 109 is used as a storage region for temporarily holding various types of data such as image data corresponding to an image capturing result.

Furthermore, the storage unit 109 is a nonvolatile storage unit represented by a flash memory, a hard disk drive (HDD), a solid state drive (SSD), a secure digital (SD) card, or the like. The storage unit 109 is also used as a permanent storage region for storing programs and the like for the system control unit 108 controlling the imaging apparatus 100, such as an operating system (OS), various programs, and various types of data.

The storage unit 109 is also used as a short-term storage region for storing various setting parameters and the like in addition to the above.

The communication unit 110 transmits image data transmitted from the system control unit 108, to the information processing apparatus 200. In addition, the communication unit 110 receives various setting commands and control commands transmitted from the information processing apparatus 200, and outputs the received commands to the system control unit 108. In addition, the communication unit 110 transmits responses of the imaging apparatus 100 to the various commands acquired from the information processing apparatus 200, to the information processing apparatus 200.

That is, the communication unit 110 is an interface (I/F) for connecting the above-described network 300 and the above-described components, and performs communication with an external apparatus such as the information processing apparatus 200 via a communication medium such as Ethernet (registered trademark). Here, the control of the imaging apparatus 100 may be performed via the communication unit 110, or may be performed via another I/F such as a serial communication I/F (not illustrated).

A case where, in the imaging apparatus 100 according to the embodiment, one system control unit 108 executes processing illustrated in a flowchart to be described below, using one storage unit 109 is exemplified. Nevertheless, the execution configuration is not limited to this. For example, a plurality of system control units and storage units may cooperatively execute processing illustrated in a flowchart to be described below. In addition, at least part of processing illustrated in the flowchart may be executed by dedicated hardware. Examples of the dedicated hardware include an application specific integrated circ unit (ASIC), a field-programmable gate array (FPGA), and the like. In addition, the processor is not limited to the CPU. The processor may be a graphics processing unit (GPU), for example.

### <Hardware Configuration of Information Processing Apparatus>

Next, an example of a hardware configuration of the information processing apparatus 200 will be described in detail with reference to FIG. 2.

The information processing apparatus 200 includes a display unit 201, the input unit 202, the storage unit 203, the system control unit 204, and a communication unit 205, and the components are connected via an internal bus (not illustrated) in such a manner that communication can be performed with each other. Programs for implementing functions according to the embodiment, and data to be used when the programs are executed are stored in a ROM included in the storage unit 203, for example. Furthermore, under the control performed by the system control unit 204, these programs and data are imported into the RAM included in the storage unit 203, for example, and executed by the system control unit 204.

As the information processing apparatus 200, a general-purpose computer such as a personal computer (hereinafter, referred to as a PC), or a mobile terminal such as a tablet is used. In other words, a general client terminal such as a PC or a tablet that includes a display unit such as a display, and an operation unit will be described as the information processing apparatus 200, but the information processing apparatus 200 is not limited to this. A terminal including a display unit such as a display, and an operation unit of the information processing apparatus 200 may be separated.

As the display unit 201, a display device such as a liquid crystal projector or a liquid crystal monitor is used, and the display unit 201 displays an image acquired from the imaging apparatus 100, and a graphic user interface (hereinafter, will be referred to as a GUI) for controlling the imaging apparatus 100. In addition, the display unit 201 displays a GUI for the creation of trace information to be described below, and the editing and reproduction of trace information.

The input unit 202 is a user interface represented by pointing devices such as a keyboard, a mouse, and a touch panel, and the like, and enables information exchange between the user and the information processing apparatus 200. Examples of the input unit 202 include an output device such as a display, and input devices such as a keyboard, a mouse, and a touch panel. The input unit 202 receives input information from the user, and transmits the received input information to the system control unit 204. In the embodiment, the description will be given assuming that the user operates a GUI displayed on the display unit 201, via the input unit 202. In addition, the user can input control information for changing an image capturing range of the imaging apparatus 100, from the input unit 202. A control method to be used at this time is not limited to a specific method. For example, an input device such as a joystick may be connected to the input unit 202. If the input unit 202 acquires the control information for changing an image capturing range of the imaging apparatus 100, the input unit 202 outputs the acquired control information to the system control unit 204.

The storage unit 203 stores camera information, and the like into an internal storage and an external storage. The storage unit 203 stores various computer programs and various types of data as information required when the system control unit 204 performs processing. That is, the storage unit 203 is a main storage memory, and is used as a work area and a temporary storage region for loading various programs. In addition, the storage unit 203 is used as a storage region for temporarily holding various types of data such as image data acquired from the imaging apparatus 100.

Furthermore, the storage unit 203 is a nonvolatile storage unit represented by a flash memory, an HDD, an SSD, an SD card, or the like. The storage unit 203 is also used as a permanent storage region for storing programs and the like for the system control unit 204 controlling the information processing apparatus 200, such as an OS, various programs, and various types of data. The storage unit 203 is also used as a short-term storage region for storing various setting parameters and the like aside from the above.

The system control unit 204 is an example of a processor represented by a CPU that comprehensively controls the entire information processing apparatus 200. In the embodiment, the system control unit 204 controls the information processing apparatus 200 in accordance with a GUI operation of the user that has been acquired via the input unit 202. Furthermore, in a case where the GUI operation of the user is an operation related to the imaging apparatus 100, the system control unit 204 generates various setting commands and control commands, and transmits the generated various setting commands and control commands to the imaging apparatus 100 via the communication unit 205. In addition, the system control unit 204 receives responses of the imaging apparatus 100 to the transmitted various setting commands and control commands, via the communication unit 205. In addition, the system control unit 204 executes the control of the information processing apparatus 200 in such a manner as to display image data received from the imaging apparatus 100 via the communication unit 205, on the display unit 201.

The communication unit 205 transmits the various commands and control commands transmitted from the system control unit 204, to the imaging apparatus 100. In addition, the communication unit 205 transmits image data transmitted from the imaging apparatus 100, and responses of the imaging apparatus 100 to the commands transmitted from the information processing apparatus 200, to the system control unit 204. That is, the communication unit 205 is an I/F for connecting the above-described network 300 and the above-described components, and performs communication with an external apparatus such as the imaging apparatus 100 via a communication medium such as Ethernet (registered trademark).

A case where, in the information processing apparatus 200 according to the embodiment, one system control unit 204 executes processing illustrated in a flowchart to be described below, using one storage unit 203 is exemplified. Nevertheless, the execution configuration is not limited to this. For example, a plurality of system control units and storage units may cooperatively execute processing illustrated in a flowchart to be described below. In addition, at least part of processing illustrated in the flowchart may be executed by dedicated hardware. Examples of the dedicated hardware include an ASIC, an FPGA, and the like. In addition, the processor is not limited to the CPU. The processor may be a GPU, for example.

In this manner, the information processing apparatus 200 can control the imaging apparatus 100 by outputting a control command to the imaging apparatus 100 via the network 300.

### <Functional Block Diagram of Information Processing Apparatus>

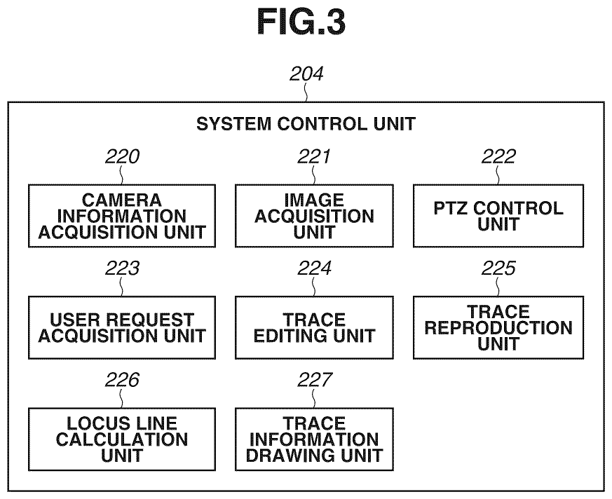

Next, functions of the system control unit 204 of the information processing apparatus 200 will be described with reference to FIG. 3. FIG. 3 is a diagram illustrating an example of functional configurations included in the system control unit 204 included in the information processing apparatus 200. As illustrated in FIG. 3, the system control unit 204 includes a camera information acquisition unit 220, an image acquisition unit 221, a PTZ control unit 222, a user request acquisition unit 223, a trace editing unit 224, a trace reproduction unit 225, a locus line calculation unit 226, and a trace information drawing unit 227. Each function illustrated in FIG. 3 is implemented by the system control unit 204 loading a program stored in a storage unit, onto the storage unit 203, and executing the program. That is, the system control unit 204 performs image processing and data calculation using these programs. In addition, the system control unit 204 executes a program stored in the storage unit 203, manages tasks such as reading, processing, and output of image data, and implements operations of the entire system.

The camera information acquisition unit 220 transmits an information acquisition command to the imaging apparatus 100 via the communication unit 205. In addition, the camera information acquisition unit 220 acquires information regarding the imaging apparatus 100, from the imaging apparatus 100, and outputs the acquired information to the storage unit 203. Here, information that can be acquired by the camera information acquisition unit 220 includes a zoom value, a pan value, and a tilt value (present values) of the lens drive unit 102, the pan drive unit 103, and the tilt drive unit 104. Furthermore, the camera information acquisition unit 220 can acquire information such as a movable range of the lens drive unit 102, the pan drive unit 103, and the tilt drive unit 104. Furthermore, in a case where the information processing apparatus 200 reproduces trace information, the camera information acquisition unit 220 outputs a zoom value, a pan value, and atilt value (present values) of the lens drive unit 102, the pan drive unit 103, and the tilt drive unit 104 to the trace information drawing unit 227.

The image acquisition unit 221 transmits an image acquisition command to the imaging apparatus 100 via the communication unit 205, acquires a captured image from the imaging apparatus 100, and outputs the captured image to the display unit 201.

The PTZ control unit 222 generates a PTZ control command via the communication unit 205 based on control information input from the trace editing unit 224 or the trace reproduction unit 225, or control information input via the input unit 202, and transmits the generated PTZ control command to the imaging apparatus 100. Here, the PTZ control command is a control command for controlling the lens drive unit 102, the pan drive unit 103, and the tilt drive unit 104 of the imaging apparatus 100. The imaging apparatus 100 controls the lens drive unit 102, the pan drive unit 103, and the tilt drive unit 104 of the imaging apparatus 100 based on the control command transmitted from the PTZ control unit 222. Here, in a case where trace information is to be reproduced, start and stop commands of trace control may be transmitted to the imaging apparatus 100, and the control of the lens drive unit 102, the pan drive unit 103, and the tilt drive unit 104 during a trace operation may be performed inside the imaging apparatus 100. In this case, trace information is stored in the storage unit 109 of the imaging apparatus 100.

The user request acquisition unit 223 receives a user request output from the input unit 202. The user request includes a “trace recording request”, a “trace editing request”, and a “trace reproduction request”. Furthermore, the “trace recording request” includes a “recording start” and a “recording stop”. The “trace editing request” includes request information of any of “point addition”, “point editing”, and “point deletion”, and the “trace reproduction request” includes request information of any of “reproduction start” and “reproduction stop”. In a case where the user request includes a “trace recording request” and a “trace editing request”, request information is output to the trace editing unit 224. In a case where the user request includes a “trace reproduction request”, request information is output to the trace reproduction unit 225.

The trace editing unit 224 performs the recording of trace information in a case where request information input from the user request acquisition unit 223 includes a trace recording request, and includes a recording start. In a case where request information input from the user request acquisition unit 223 includes a trace recording request, and includes a recording stop, the trace editing unit 224 stops the recording of trace information. Similarly, in a case where request information input from the user request acquisition unit 223 includes a trace editing request, the trace editing unit 224 reads out trace information stored in the storage unit 203, and performs the editing of the trace information. In a case where the request information includes “point addition”, the trace editing unit 224 adds a new locus point to trace information based on a parameter corresponding to a position to which a graph operation has been added.

Here, in the embodiment, the locus point is a point having pan and tilt angles (a target position) desired to be surely reached, which is designated by the user in the trace information. Furthermore, the locus point is a point having information (identification information) regarding an elapsed time from a trace start (a time from trace reproduction until angles reach the pan and tilt angles). Furthermore, the locus point is a point having parameters for calculating a locus line connecting a locus point and a next locus point, and calculating a control point included in a locus line. In other words, the control point is a point included in a locus line connecting a locus point and a next locus point. The control point is a parameter including information regarding pan and tilt angles, and an elapsed time.

That is, the locus point is a parameter set by the user, and the control point is a parameter calculated from the locus point set by the user. The control point is determined by performing piecewise cubic Hermite interpolation using two or three control points. An interpolation method to be used when the control point is determined may be another interpolation method as long as the method can acquire information necessary to smoothly connect a locus point with previous and next locus points, such as cubic spline interpolation or Akima interpolation. In this manner, the control point is determined based on an input locus point. The calculation methods of control points and locus lines will be described below.

In the embodiment, the description will be given assuming that the locus point is a point having pan and tilt angles, but the locus point is not limited to this. For example, the locus point may have a parameter related to a zoom position. In this case, information regarding a zoom position that is included in the locus point is a zoom position desired to be surely reached that is designated by the user.

In a case where request information input from the user request acquisition unit 223 includes “point editing”, the trace editing unit 224 changes the PT (Z) position and the elapsed time that are related to a locus point to be edited, or changes a parameter for calculating a locus line to be edited. In a case where request information input from the user request acquisition unit 223 includes “point deletion”, the trace editing unit 224 deletes a locus point being edited, from trace information.

The trace reproduction unit 225 reads out trace information stored in the storage unit 203, from request information input from the user request acquisition unit 223, and executes reproduction processing of a trace. In a case where the request information includes a “reproduction start”, the trace reproduction unit 225 outputs control information to the PTZ control unit 222, and outputs time information to the trace information drawing unit 227. In a case where the request information includes a “reproduction stop”, the trace reproduction unit 225 stops reproduction by stopping information being output to the PTZ control unit 222 and the trace information drawing unit 227.

The locus line calculation unit 226 performs the calculation of a locus line connecting between locus points, from information regarding each locus point of trace information to be described below. In the embodiment, a time-pan locus line indicating a relationship between time and pan, and a time-tilt locus line indicating a relationship between time and tilt are individually calculated using a cubic Bezier curve. In the embodiment, a locus line is calculated using a cubic Bezier curve, but another locus may be used as long as a locus indicating the transitions of time, pan, and tilt can be represented, such as a cubic spline curve or a Lagrange interpolation polynomial.

The trace information drawing unit 227 creates items to be displayed on the display unit 201, based on time information and control information input from the camera information acquisition unit 220 and the trace reproduction unit 225. The items to be displayed will be described below.

### <Creation and Editing Methods of Trace Information>

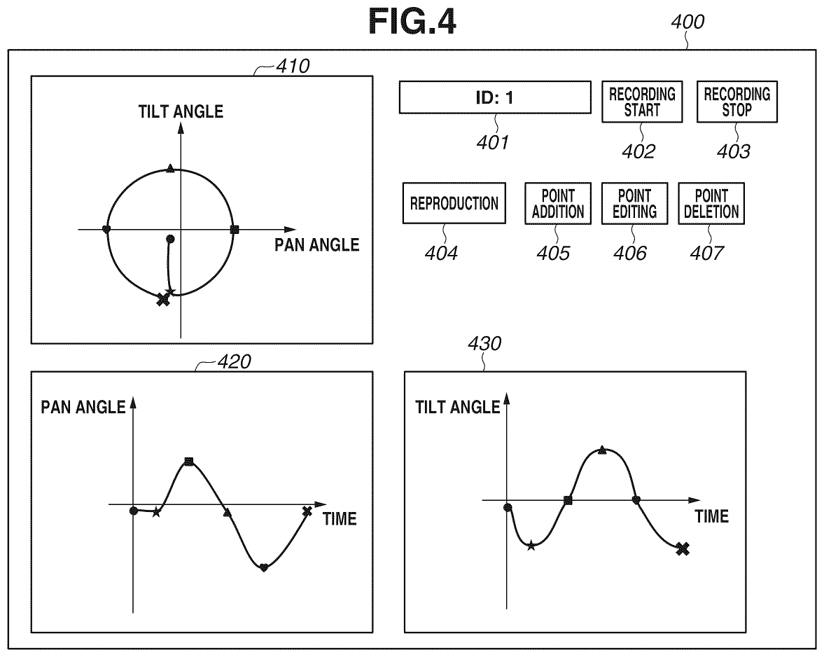

Next, creation and editing methods of trace information according to the first embodiment will be described with reference to FIG. 4. A GUI 400 in FIG. 4 is a setting screen for creation, editing, and reproduction of trace information that is to be displayed on the display unit 201 of the information processing apparatus 200.

The GUI 400 in FIG. 4 includes a trace ID 401 being information for identifying trace information, and a recording start button 402 for issuing a recording (creation) start instruction of trace information. The GUI 400 further includes a recording stop button 403 for issuing a recording stop instruction of trace information, and a reproduction button 404 for issuing a reproduction instruction and a reproduction stop instruction of trace information. The GUI 400 also includes a point addition button 405, a point editing button 406, and a point deletion button 407 for switching an edit state of trace information when trace information is edited. The GUI 400 further includes a pan-tilt graph 410 (first information display region) being a two-dimensional graph indicating a relationship between a pan value and a tilt value. The GUI 400 also includes a time-pan graph 420 (second information display region) being a two-dimensional graph indicating a relationship between a pan value and time, and a time-tilt graph 430 (second information display region) being a two-dimensional graph indicating a relationship between a tilt value and time.

Here, the time indicated on horizontal axes of the time-pan graph 420 and the time-tilt graph 430 indicate the elapsed time from a time point at which the reproduction of trace information is started. In the GUI 400 in FIG. 4, a graph that is based on created trace information is displayed. In the embodiment, the pan-tilt graph 410, the time-pan graph 420, and the time-tilt graph 430 are displayed, but graphs to be displayed are not limited to these. For example, a graph (time-zoom graph) related to a zoom value may be displayed. In addition, a three-dimensional graph indicating a pan value, a tilt value, and a zoom value may be displayed.

In this manner, the user can create trace information and edit the created trace information by performing operations on a displayed graph.

The trace ID 401 is an ID (hereinafter, trace ID) for uniquely identifying a series of pieces of created trace information, and in the example illustrated in FIG. 4, by the user clicking the trace ID 401, respective trace IDs corresponding to pieces of registered trace information are displayed as a list. In addition, regarding the trace ID 401, trace ID addition (not illustrated) can be selected, and if the trace ID addition is selected, a new trace ID is allocated, and displayed in a selected state in the trace ID 401.

In the trace ID 401, for example, ten fixed trace IDs may be displayed as a list.

The recording start button 402 is a button for creation of trace information, and by the user pressing the recording start button 402, the creation of trace information starts.

The recording stop button 403 is a button for stopping the recording of trace information being created.

By the user pressing the recording stop button 403, the creation of trace information is stopped, and the storage unit 203 records trace information from a creation start of trace information until the creation is stopped, in association with a trace ID selected in the trace ID 401. In the embodiment, the recording start button 402 and the recording stop button 403 are used when trace information is created by controlling the imaging apparatus 100 to be described below, but the configuration is not limited to this. The recording start button 402 and the recording stop button 403 may be used when trace information is created by a graph operation to be described below.

The reproduction button 404 is a button for reproducing created trace information, and by the user pressing the reproduction button 404, trace information associated with the selected trace ID 401 is read out from the storage unit 203, and the following processing is executed. In other words, the system control unit 204 controls the imaging apparatus 100 to trace the transition of a parameter with reference to the trace information. In this manner, processing of controlling the imaging apparatus 100 to trace the transition of a parameter that is made by a user operation, with reference to trace information will be referred to as trace reproduction. In addition, if the reproduction button 404 is pressed once again in a state in which the reproduction button 404 is pressed, trace reproduction on the imaging apparatus 100 is stopped.

The point addition button 405 is a button for adding a locus point, and if the user presses the point addition button 405, a “trace editing request” including “point addition” is output to the user request acquisition unit 223 via the input unit 202. If any of the graphs to be described below is operated in a state in which the point addition button 405 is pressed, a locus point is added to a corresponding position. In this manner, the trace editing unit 224 can add a new locus point to trace information with a trace ID selected in the trace ID 401, based on a parameter corresponding to a position to which a graph operation has been added.

The point editing button 406 is a button for editing trace information, and if the user presses the point editing button 406, a “trace editing request” including “point editing” is output to the user request acquisition unit 223 via the input unit 202. If any of the graphs to be described below is operated in a state in which the point editing button 406 is pressed, and a locus line, a locus point, or a control point is dragged, a target position of a corresponding point, an elapsed time, or the position of the control point can be changed.

The point deletion button 407 is a button for deleting a control point, and if the user presses the point deletion button 407, a “trace editing request” including “point deletion” is output to the user request acquisition unit 223 via the input unit 202. If a point drawn in any of the graphs to be described below is selected in a state in which the point deletion button 407 is pressed, trace information about a corresponding point can be deleted.

In this manner, pressing the point addition button 405, the point editing button 406, or the point deletion button 407 switches a state between a state in which “point addition”, “point editing”, or “point deletion” is executable, and a state in which “point addition”, “point editing”, or “point deletion” is inexecutable. Each button has two states corresponding to a pressed state and an unpressed state.

The pan-tilt graph 410 is a two-dimensional graph indicating a relationship between pan and tilt in trace information illustrated in FIG. 4. When the point addition button 405 is in the pressed state, by clicking a mouse button, for example, at any location on the pan-tilt graph 410, the user can add a locus point to the location. When the point editing button 406 is in the pressed state, the user operates any locus point or control point on the pan-tilt graph 410. The target position of pan or tilt of the locus point, or the position of the control point can be changed in accordance with the operation. For example, the user may be enabled to operate the locus point by selecting a locus point by clicking the mouse button, and dragging the locus point or the control point.

At this time, in one embodiment, in order to distinguish a selected locus point from others, only the selected locus point may be highlighted by changing the color, the size, the shape, or the like of the locus point. When the point deletion button 407 is in the pressed state, by selecting any locus point on the pan-tilt graph 410 by clicking the mouse button, for example, the user can delete the locus point.

In the embodiment, for example, in a case where an elapsed time of an initially-added locus point on the pan-tilt graph 410 is assumed to be zero, if the next locus point is added, a time obtained by adding a predetermined time to the elapsed time of the last locus point is set as an elapsed time in locus point information about the added locus point.

Here, when the user adds a locus point, an elapsed time obtained by adding a predetermined time to the elapsed time of the last locus point is set, but the configuration is not limited to this. For example, an elapsed time from a time at which the point addition button 405 is pressed may be set.

The time-pan graph 420 is a two-dimensional graph indicating a relationship between time and a pan value in the trace information illustrated in FIG. 4. When the point addition button 405 is in the pressed state, by clicking the mouse button, for example, at an arbitrary location on the time-pan graph 420, the user can add a locus point to the location. At this time, a tilt value of zero is recorded at the locus point, but the tilt value is not limited to this. For example, the same tilt value as a tilt value of a locus point closest to the added locus point may be input, or the user may input a tilt value when the locus point is added. When the point editing button 406 is in the pressed state, the user selects any locus point on the time-pan graph 420 by clicking the mouse button, for example. By dragging the selected locus point or a control point, it is possible to change a pan target position of the locus point, an elapsed time, or the position of the control point. When the point deletion button 407 is in the pressed state, by selecting any locus point on the time-pan graph 420 by clicking the mouse button, for example, the user can delete the selected locus point.

The time-tilt graph 430 is a two-dimensional graph indicating a relationship between time and a tilt value in the trace information illustrated in FIG. 4. When the point addition button 405 is in the pressed state, by clicking the mouse button, for example, at any location on the time-tilt graph 430, it is possible to add a locus point to the location. At this time, a pan value of zero is recorded at the locus point, but the pan value is not limited to this. For example, the same pan value as a pan value of a locus point closest to the added locus point may be input, or the user may input a pan value when the locus point is added. When the point editing button 406 is in the pressed state, the user selects any locus point on the time-tilt graph 430 by clicking the mouse button, for example. By dragging the selected locus point or a control point, it is possible to change a tilt target position of the locus point, an elapsed time, or the position of the control point. When the point deletion button 407 is in the pressed state, by selecting any locus point on the time-tilt graph 430 by clicking the mouse button, for example, the user can delete the selected locus point.

In this manner, if a graph region is operated and a locus point is initially added, information associating zero as a pan value, a tilt value, and an elapsed time corresponding to the imaging apparatus 100, based on the locus point is recorded as locus point information. With this configuration, by operating and editing one two-dimensional graph, it becomes possible to set two parameters that can be designated on the two-dimensional graph, and a parameter that is not designated on the two-dimensional graph, as locus point information.

In the embodiment, if a locus point is created on the pan-tilt graph 410, the position of the created locus point, and a pan value and a tilt value of a corresponding location on the pan-tilt graph 410 are recorded as locus point information. Furthermore, a preset elapsed time is recorded as locus point information.

Similarly, if a locus point is created on the time-pan graph 420, the position of the created locus point, a pan value of a corresponding location on the time-pan graph 420, and an elapsed time are recorded as locus point information. Furthermore, a preset tilt value is recorded as locus point information. If a locus point is created on the time-tilt graph 430, the position of the created locus point, a tilt value of a corresponding location on the time-tilt graph 430, and an elapsed time are recorded as locus point information. Furthermore, a preset pan value is recorded as locus point information.

Here, trace information may be recorded by controlling the imaging apparatus 100, or may be created by the user adding a locus point to the pan-tilt graph 410 being a two-dimensional graph indicating a relationship between a time and a pan value and a tilt value in a trace.

As described above, by adding, editing, or deleting a locus point, the user can record trace information in association with one trace ID, but the configuration is not limited to this. For example, an upper limit time may be preset. In this case, in a case where an elapsed time from a time point at which a locus point is initially added reaches a set time, the storage unit 203 may stop trace recording, and store sequentially-recorded trace information into a trace information table. In addition, in a case where a preset time elapses from a time point at which a locus point is added, edited, or deleted, the storage unit 203 may stop trace recording, and store sequentially-recorded trace information into a trace information table. The time to be used at this time may be set and changed by the user, or may be determined as a default setting or the like.

The above-described operation of point addition/point editing/point deletion is not limited to a graph operation, and may be implemented by a numerical value input, for example.

Furthermore, also in a case where already-created trace information is edited, it is possible to perform similar control. In this case, if the user designates a trace ID of trace information desired to be edited, in the trace ID 401, trace information stored in the storage unit 203 is read out, and drawn by the trace information drawing unit 227. The user can edit trace information by an operation similar to an operation performed when trace information is created. A specific control flow will be described below.

Next, a method of creating trace information by controlling the imaging apparatus 100 will be described.

If the recording start button 402 is pressed by the user and trace information creation is started, the user performs an operation for creating trace information, on the imaging apparatus 100. By being pressed by the user when trace information creation has been started, the recording stop button 403 stops the trace information creation. Furthermore, the storage unit 203 records trace information from a creation start of trace information until the creation is stopped, in association with a trace ID selected in the trace ID 401.

First of all, an operation of recording trace information by controlling the imaging apparatus 100 will be described. Here, if the user inputs control information for controlling the imaging apparatus 100, via the input unit 202, a control command of the imaging apparatus 100 is sequentially generated in accordance with a user operation, and the control command is transmitted to the imaging apparatus 100, whereby the control of the imaging apparatus 100 is realized. For example, in a case where a joystick is connected to the input unit 202, if a user operation of tilting the joystick in a left-right direction is performed, the PTZ control unit 222 generates a control command in accordance with the input user operation, and transmits the control command to the imaging apparatus 100.

In addition, in a case where a user operation of tilting the joystick in an up-down direction is performed, the PTZ control unit 222 generates a control command for changing a tilt value, and transmits the control command to the imaging apparatus 100. In the recording of trace information, the storage unit 203 records the transition of a parameter of the imaging apparatus 100 that is sequentially changed by a user operation, and corresponding time information (temporal transition of pan and tilt angles), as trace information associated with a currently-selected trace ID. In the embodiment, in the case of recording trace information by controlling the imaging apparatus 100 of the user, the recording trace information will be described as recording the transition of a parameter in a predetermined cycle. In this case, a pan value, a tilt value, and a zoom value in the predetermined cycle are recorded in association with a locus point. That is, a pan value, a tilt value, and a zoom value obtained every two seconds, for example, from when the recording start button 402 is pressed, are used in association with a locus point, and recorded as trace information.

The information processing apparatus 200 records the transition of a parameter of a sequentially-added locus point, and corresponding time information (temporal transitions of pan and tilt angles), as trace information associated with a currently-selected trace ID, until the recording stop button 403 is pressed.

As described above, by performing an operation on the imaging apparatus 100 in a state in which the recording start button 402 is pressed by the user, trace information creation is implemented. That is, the information processing apparatus 200 records the transition of a sequentially-changed parameter of the imaging apparatus 100, and corresponding time information, as trace information associated with a currently-selected trace ID, until the recording stop button 403 is pressed.

In the embodiment, the description will be given assuming that two methods corresponding to creating trace information by controlling the imaging apparatus 100, and creating trace information using the point addition button 405, the point editing button 406, and the point deletion button 407 are included, but the method is not limited to this. In one embodiment, a GUI for selecting a method to be used in recording trace information may be displayed on the display unit 201, and only either one of the methods may be included.

### (Reproduction of Trace Information)

In a case where the reproduction button 404 is pressed by the user, the system control unit 204 reads trace information associated with the selected trace ID 401, from the storage unit 203, and the following processing is executed. If the reproduction button 404 is pressed, a trace reproduction request including a “reproduction start” is transmitted to the user request acquisition unit 223, and the reproduction button 404 becomes a button for transmitting a trace request including a reproduction stop. That is, if the reproduction button 404 is pressed during the reproduction of trace information, a trace request including a “reproduction stop” is transmitted to the user request acquisition unit 223. In addition, if the reproduction of trace information ends, the state transitions to a stopped state, and the reproduction button 404 becomes a reproduction button for transmitting a trace request including a reproduction start.

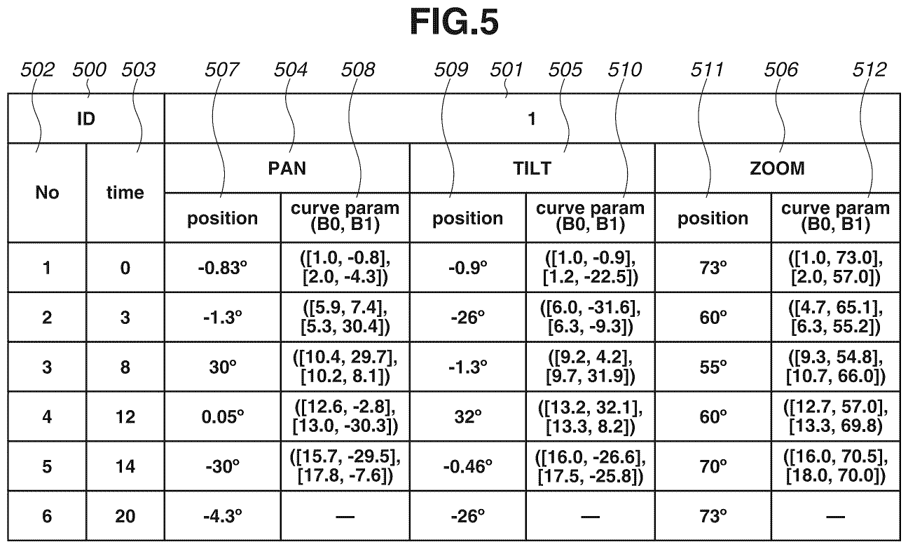

Here, a trace information table will be described with reference to FIG. 5. A trace information table 500 illustrated in FIG. 5 is an example of a table for storing trace information. In the trace information table 500, a trace ID 501, and trace information obtained by trace recording are stored in association.

The trace ID 501 is an ID for uniquely identifying trace information, and is the same as an ID displayed in the trace ID 401. The trace information is a recorded operation of the imaging apparatus 100 that is performed by the user during a predetermined period, or locus point information set by the user, and is referred to during trace reproduction. A locus point number 502 indicates the number of a locus point added to trace information. An elapsed time 503 indicates an elapsed time from a trace start at a time point at which the position reaches a locus point. In pan information 504, tilt information 505, and zoom information 506, information regarding pan, tilt, and zoom for each locus point is described. In pan angle information 507, tilt angle information 509, and zoom position information 511, a target position of a locus point is described. In pan control point information 508, tilt control point information 510, and zoom control point information 512, a parameter for calculating a locus line (or control point included in a locus line) is described.

Specifically, the locus line calculation unit 226 performs the calculation of a locus line connecting between locus points, from information regarding the locus points of trace information to be described below. In the embodiment, the locus line calculation unit 226 calculates a time-pan locus line indicating a relationship between time and pan, and a time-tilt locus line indicating a relationship between time and tilt, using a cubic Bezier curve. In the embodiment, a locus line is calculated using a cubic Bezier curve, but another locus may be used as long as a locus indicating the transitions of time, pan, and tilt can be represented, such as a cubic spline curve or a Lagrange interpolation polynomial.

A calculation formula of the cubic Bezier curve is represented as follows using a starting point P0, an ending point P1, a control point B0, a control point B1, and a parameter t.

$$C ( t ) = {( 1 - t )}^{3} {P}_{0} + 3 {( 1 - t )}^{2} {tB}_{0} + 3 ( 1 - t ) {t}^{2} B \text{?} + {t}^{3} P \text{?} ( 0 \leq t \leq 1 )$$

$$\text{?} \text{indicates text missing or illegible when filed}$$

Here, coordinates of the starting point P0 and the ending point P1 are an elapsed time and a target position of a locus point, respectively, and coordinates of control points are values described in the pan control point information 508, the tilt control point information 510, and the zoom control point information 512 of the trace information in FIG. 5. For example, in the case of calculating a time-pan locus line from a locus point with a locus point number of 1 to a locus point with a locus point number of 2 in the trace information in FIG. 5, the coordinates of the starting point P0 and the ending point P1 become the starting point P0 (0.0, −0.83) and the ending point P1 (3.0, −1.3). In addition, the coordinates of control points become the control point B0 (1.0, −0.8) and the control point B1 (2.0, −4.3). A pan-tilt locus line indicating a relationship between pan and tilt is calculated based on a time-pan locus line and a time-tilt locus line.

A method for calculating a locus line will be described below. In the embodiment, trace information is recorded in association with time information for each row. In this example, if the user presses the trace reproduction button 404 in FIG. 4, as drawn in the pan-tilt graph 410 in FIG. 4, from the locus point number 1 toward the locus point number 2 in FIG. 5, pan is in an almost-stationary state and tilt is driven downward. From a locus point number 3 toward a locus point number 6, pan and tilt are driven counterclockwise in such a manner as to draw a circle. From the locus point number 1 toward the locus point number 3, zoom moves to a telephoto (TELE) side, and returns to a wide side toward the locus point number 6.

The trace information according to the embodiment is not limited to a parameter related to a pan value, and a parameter related to a tilt value, and other parameters may also be recorded. For example, the trace information may be a parameter of white balance, a parameter of an exposure value, or a parameter of image quality. Similarly, in the one embodiment, a parameter of a zoom value need not be recorded. Only parameters of the pan value and the tilt value may be recorded as trace information. In this manner, by recording only parameters of the pan value and the tilt value as trace information, it is also possible to apply the embodiment to a camera platform connected to the imaging apparatus 100.

### (Flow of Control to Be Executed at Time of Editing of Trace Information)

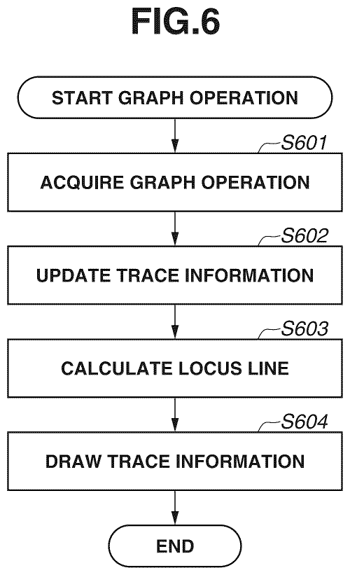

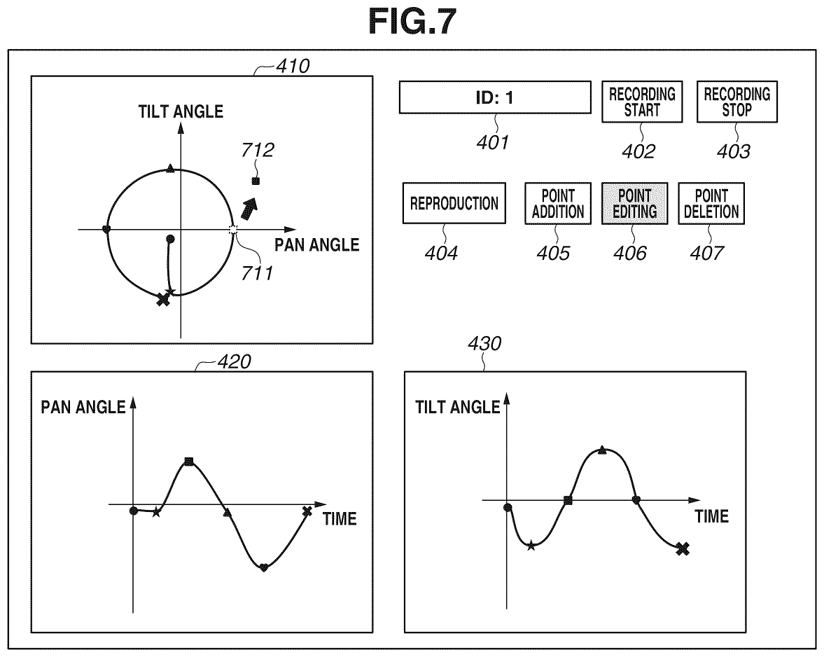

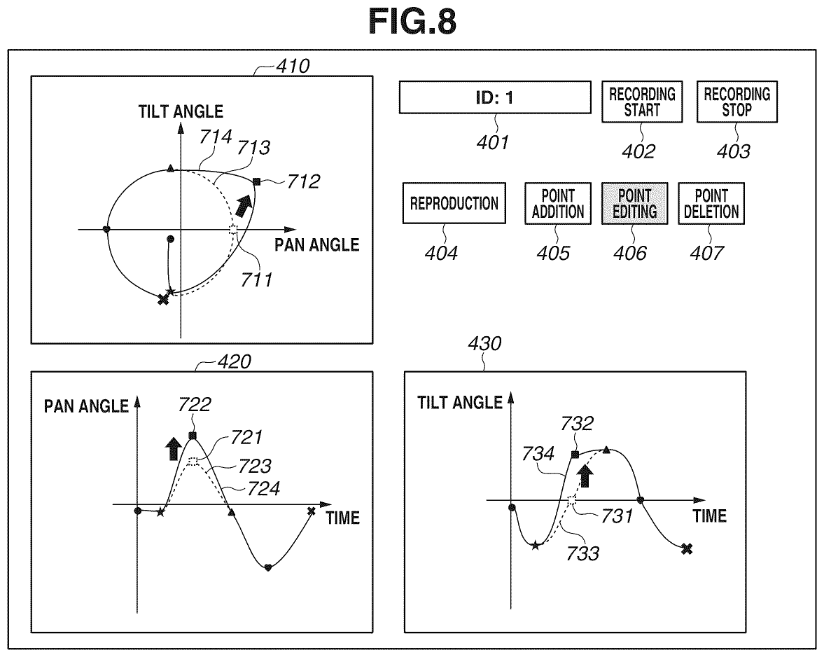

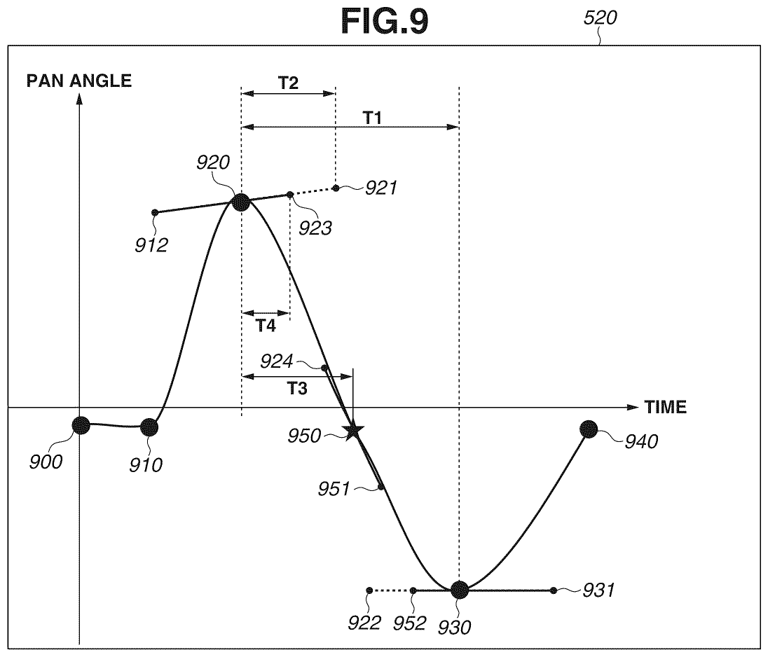

Here, a flow of processing to be executed by the system control unit 204 according to the first embodiment will be described with reference to FIGS. 6, 7, 8, and 9. FIG. 6 is a flowchart illustrating a flow of processing of creating and editing a trace in any graph of the pan-tilt graph 410, the time-pan graph 420, and the time-tilt graph 430 displayed on the display unit 201. The processing in this flowchart is started by the user operating a GUI displayed on the display unit 201, via the input unit 202, and ends by a trace being drawn on the GUI as indicated by a trace creation or editing instruction issued by the user. FIGS. 7 and 8 each illustrate a display example of a GUI to be displayed on the display unit 201 when the processing is performed. FIG. 7 illustrates a setting screen for creation, editing, and reproduction of trace information to be displayed on the display unit 201 of the information processing apparatus 200. A GUI 400 includes a trace ID 401 indicating identification information about trace information to be recorded. The GUI 400 further includes a recording start button 402 for issuing a trace recording start instruction, a recording stop button 403 for issuing a trace recording stop instruction, and a reproduction button 404 issuing a reproduction instruction and a stop instruction of trace recording. The GUI 400 also includes a point addition button 405, a point editing button 406, and a point deletion button 407 for switching a trace edit state. The GUI 400 further includes a pan-tilt graph 410 being a two-dimensional graph indicating a relationship between a pan value and a tilt value, a time-pan graph 420 being a two-dimensional graph indicating a relationship between a pan value and an elapsed time, and a time-tilt graph 430 being a two-dimensional graph indicating a relationship between a tilt value and an elapsed time. Furthermore, an unedited locus point 711 and an edited locus point 712 are newly added onto the pan-tilt graph 410. In FIG. 8, unchanged locus points 721 and 731, unchanged locus lines 713, 723, and 733, changed locus points 722, and 732, and changed locus lines 724, and 734 are newly added to the pan-tilt graph 410 illustrated in FIG. 7. FIG. 9 illustrates how a control point position changes when the user adds a locus point. The details of FIG. 9 will be described below.

In step S601, the user request acquisition unit 223 acquires an operation performed by the user on a GUI displayed on the display unit 201. In accordance with which button among the point addition button 405, the point editing button 406, and the point deletion button 407 is in a pressed state, the acquired request information is output to the trace editing unit 224, and the processing proceeds to step S602. For example, in a GUI display example illustrated in FIG. 7, an example in which the point editing button 406 is in the pressed state is illustrated. In a case where a user operation performed in a state in which the point editing button 406 is pressed is acquired, the user request acquisition unit 223 outputs information indicating a graph on which the user operation has been executed, and information including “point editing” in a “trace editing request”, to the trace editing unit 224.

In step S602, the trace editing unit 224 updates trace information in accordance with the input graph information and request information. In a case where the request information includes “point addition”, a request may be transmitted to the user in such a manner that the user additionally inputs information that cannot be acquired from the graph operated by the user, or interpolation may be performed.

In a case where an input request is issued to the user, the trace editing unit 224 outputs an input request command to the trace information drawing unit 227, and the trace information drawing unit 227 performs control (display control) in such a manner as to display a GUI for issuing an input request to the user, on the display unit 201. In a case where interpolation is performed, in the case of performing point addition on the pan-tilt graph 410, for example, information regarding a locus point having pan and tilt target positions corresponding to a position designated on the pan-tilt graph 410 is added to a trailing end of the trace information. As an elapsed time of the added locus point information, an elapsed time obtained by adding a predetermined time to an elapsed time of the last point is set. A control point of the added locus point information is left blank, and is determined by performing piecewise cubic Hermite interpolation using previous two or three points as control points of the previous locus point information. An interpolation method to be used when the control point is determined may be another interpolation method as long as the method can acquire information necessary to smoothly connect the added locus point with previous and next locus points, such as cubic spline interpolation or Akima interpolation.

In addition, in a case where a user operation indicating “point addition” on the time-pan graph 420 is acquired, a locus point having an elapsed time and a pan target position that correspond to a position designated on the time-pan graph 420 is added to trace information. In a case where the elapsed time that corresponds to the designated position is larger than an elapsed time at the trailing end of a locus point registered in trace information, a locus point is added to the trailing end of trace information. At this time, a tilt target position of the previous point is set as a tilt target position. A control point of the added locus point information is left blank, and is determined by performing piecewise cubic Hermite interpolation using previous two or three points as control points of the previous locus point information. In a case where the elapsed time that corresponds to the designated position is that at the position between any locus points among locus points registered in trace information, a locus point is added at the position between the locus points in the trace information. At this time, a position on a time-tilt locus line at the elapsed time that corresponds to the designated position is set as a tilt target position. A calculation method of values of control points of the added locus point information and the previous locus point information will be described with reference to FIG. 9.

FIG. 9 illustrates how a new locus point is added between two locus points on the time-pan graph 420. A locus point 900, a locus point 910, a locus point 920, a locus point 930, and a locus point 940 are locus points already registered in trace information, a locus point 950 is a locus point newly added by the user, and a control point 912 is the control point B1 of locus point information about the locus point 910. Control points 921 and 923 are unchanged and changed control points B0 of locus point information about the locus point 920, respectively, and control points 922 and 924 are unchanged and changed control points B1 of locus point information about the locus point 920, respectively. A control point 931 is the control point B0 of the locus point 930, and control points 951 and 952 are the control point B0 and the control point B1 of locus point information about the added locus point 950, respectively. Here, a method of calculating the control points 951 and 952 of added locus point information, and the control points 923 and 924 of locus point information about the previous locus point 920 will be described.

First of all, the control points 924 and 951 are determined by performing piecewise cubic Hermite interpolation using the locus points 920 and 930 being previous and next existing locus points, and the added locus point 950. Regarding the control point 923, first of all, a value of a temporal axis component is calculated in such a manner as to satisfy the following equation. In this equation, a ratio of a time (T2) from the locus point 920 to the control point 921 with respect to a time (T1) from the locus point 920 to the locus point 930, and a ratio of a time (T4) from the locus point 920 to the control point 923 with respect to a time (T3) from the locus point 920 to the locus point 950 are kept constant. In the following equation, P0 denotes the previous locus point 920, P1 denotes the next locus point 930, P2 denotes the added locus point 950, B0 denotes the control point 921, and C0 denotes the control point 923.

$$( B 0 t - P 0 t ) / ( P 1 t - P 0 t ) = ( C 0 t - P 0 t ) / ( P 2 t - P 0 t ) \qquad ( 1 )$$

After that, values of pan and tilt axis direction components are calculated in such a manner that the inclination of a tangent line at the previous locus point 920 becomes the same as the original inclination.

Regarding the control point 952, first of all, a value of a temporal axis component is calculated in such a manner as to satisfy the following equation. In the following equation, P0 denotes the previous locus point 920, P1 denotes the next locus point 930, P2 denotes the added locus point 950, B1 denotes the control point 922, and C1 denotes the control point 952.

$$( P 1 t - B 1 t ) / ( P 1 t - P 0 t ) = ( P 1 t - C 1 t ) / ( P 1 t - P 2 t ) \qquad ( 2 )$$

After that, values of pan and tilt axis direction components are calculated in such a manner that the inclination of a tangent line at the next locus point 930 becomes the same as the original inclination.

Furthermore, in a case where point addition has been performed on a time-tilt graph 430, the addition of a locus point is performed similarly to a case where point addition has been performed on a time-pan graph 420.

In a case where request information includes “point editing”, trace information is changed at a position designated by the user on a graph. For example, in a case where a user operation indicating “point editing” is acquired on the pan-tilt graph 410, the positions of locus points of pan and tilt of the locus point of trace information, and the positions of pan and tilt axis components of a control point are changed in accordance with a position designated on the pan-tilt graph 410. In a case where the locus point is changed, because pan and tilt axis components of the control point also move in parallel, the positions of pan and tilt axis components of the control point B0 of the locus point and the control point B1 of the previous locus point are changed by the same amount as the change amount. In a case where the positions of pan and tilt axis components of the control point B0 of pan and tilt are changed, the control point B1 of the previous point may be changed in conjunction in such a manner that a movement at the locus point becomes smooth.

In a case where the control point B1 is changed in conjunction, a value of a temporal axis component of the control point B1 of the previous point is set to the same value. Furthermore, pan and tilt axis components of the control point B1 of the previous point are recalculated in such a manner that the changed control point B0, the locus point, and the control point B1 of the previous point line up in a straight line on the time-pan graph 420 and the time-tilt graph 430. In a case where the positions of pan and tilt axis components of the control point B1 of pan and tilt are changed, the control point B0 of the next point may be changed in conjunction in such a manner that a movement at the locus point becomes smooth. In a case where the control point B0 is changed in conjunction, a value of a temporal axis component of the control point B0 of the next point is set to the same value. Pan and tilt axis components of the control point B0 of the next point are recalculated in such a manner that the changed control point B1, a locus point of the next point, and the control point B0 of the next point line up in a straight line on the time-pan graph 420 and the time-tilt graph 430.

In addition, in a case where a user operation indicating “point editing” is acquired on the time-pan graph 420, a pan target position of the locus point of trace information, an elapsed time, and the position of a control point are changed.

In the case of performing the change of target positions, the positions of pan axis components of the control point B0 of edited locus point information, and the control point B1 of the previous locus point are changed by the same amount as the change amount.

In the case of performing the change of an elapsed time, first of all, temporal axis components of the control points B0 and B1 of edited locus point information, and the control points B0 and B1 of previous locus point information are calculated in such a manner as to satisfy Equations (1) and (2) described above, and changed. After that, regarding values of pan and tilt axis components of the control points B0 and B1 of the edited locus point information and the previous locus point information, values corresponding to values of temporal axis components of the changed control point B0 and control point B1 at each locus point are calculated in such a manner as to keep the inclination of a tangent line at each locus point.

Furthermore, in the case of performing the change of a control point, in the case of changing the positions of pan and tilt axis components, control points of previous and next points may be changed in conjunction similarly to a case where a change is made on the pan-tilt graph 410. Furthermore, in a case where a user operation indicating “point editing” is acquired on the time-tilt graph 430, trace information is changed similarly to a case where a user operation indicating “point editing” is acquired on the time-pan graph 520. In a case where the previous locus point and the next locus point do not exist, only information regarding the locus point is changed. In addition, in a case where a control point does not exist, no change is to be made.

In a case where request information includes “point deletion”, information regarding a locus point designated by the user on a graph is deleted from trace information. At this time, in a case where a locus point at the trailing end is deleted, a control point of a locus point that newly comes at the trailing end is deleted. In a case where a point between a locus point and a locus point is deleted, the recalculation of a control point of a previous locus point of a deleted locus point is performed. A recalculation method is obtained by reading a locus point of which an elapsed time has been changed, as the next locus point of the locus point deleted this time, in the above-described method of recalculating a value of a control point when an elapsed time of a locus point is changed on the time-pan graph 520.

As described above, after control corresponding to request information from the user is performed, the processing proceeds to step S603. In the GUI display example illustrated in FIG. 7, because the locus point 711 on the pan-tilt graph 410 is changed to the locus point 712, pan and tilt target positions of trace information about a corresponding locus point are changed in accordance with the coordinate of a graph.

In step S603, the locus line calculation unit 226 calculates a locus line at a location where trace information is edited, and a locus line in its periphery. In a case where any value related to pan is changed in trace information, a time-pan locus line between the locus point and the next locus point is calculated, and in a case where any value related to tilt is changed in trace information, a time-tilt locus line between the locus point and the next locus point is calculated. Regarding a locus point of which a value of a control point does not exist, the calculation of a locus line to the next locus point is not performed. In a case where the number of locus points connecting to a changed locus point is zero, because a locus line does not exist, the processing directly proceeds to step S604. Lastly, in a section in which either a time-pan locus line or a time-tilt locus line is calculated, a pan-tilt locus line is calculated based on a time-pan locus line and a time-tilt locus line, and the processing proceeds to step S604.

In step S604, the trace information drawing unit 227 performs drawing in three graphs displayed on the display unit 201, based on the trace information updated in step S602, and the locus line calculated in step S603 (display control). In the pan-tilt graph 410, a pan-tilt locus line, and pan and tilt coordinates at each locus point are drawn. In the time-pan graph 420, a time-pan locus line, and time and pan coordinates at each locus point are drawn, and in the time-tilt graph 430, a time-tilt locus line, and time and tilt coordinates at each locus point are drawn (display control).

FIG. 8 illustrates a state in which the position of a locus point moves from the locus point 721 to the locus point 722 in the time-pan graph 420, and the position of a locus point moves from the locus point 731 to the locus point 732 in the time-tilt graph 430, in accordance with the user moving the position of the locus point 711 to the locus point 712 on the pan-tilt graph 410. In addition, locus lines in a previous and next sections of a locus point changed in accordance with the movement of the locus point in three graphs are newly drawn again from the locus line 713 to the locus line 714, from the locus line 723 to the locus line 724, and from the locus line 733 to the locus line 734. At this time, to clearly indicate correspondence between locus points and locus lines, the color or shape of a marker may be changed for each number of a locus point, or the color or the line type of a locus line may be changed for each number of a locus point.

In addition, to clearly indicate a change in movement of the imaging apparatus 100 when locus point information is edited, the display of a locus line in a predetermined range may be changed. In one embodiment, the color of a locus line connecting previous and next locus points of a selected locus point may be changed depending on a control item in a corresponding section, to distinguish among a section in which only pan is driven, a section in which both pan and tilt are driven, and the like. For example, in a case where a locus line connecting the previous locus point of a locus point selected in the pan-tilt graph 410 is displayed in a color to be used when only pan is driven, if a control point position of the selected locus point, or the like is changed, it is clearly indicated that a tilt stop state in the previous section is to be changed.

Furthermore, in a case where locus points having the same pan and tilt angles exist in trace information, display may be differentiated. For example, all locus points at the same position may be enabled to be simultaneously checked (simultaneous display) by setting the size of a marker for a slow elapsed time to a smaller size, displaying a marker in either the left half or the right half or one-third at a time (division), or the like. A positional relationship of each marker and a locus line may be swapped every several seconds (displayed in a predetermined order). Moreover, when trace information becomes long, or the like, by making an arbitrary range of locus points in trace information selectable, in one embodiment, only locus points in a selected range may be drawn on a graph.

The drawing range may be automatically set. For example, there is a method of drawing locus points previous and next to a locus point lastly-added or selected, by the number corresponding to a predefined time, or by a predefined number of locus points, a method of drawing locus points in either range of previous and next ranges of locus point having the same pan and tilt angles (display range setting), or the like.

As described above, when an instruction to create or edit a trace is received on a predetermined graph from a GUI, a designated change in trace information can be simultaneously displayed in a pan-tilt graph, a time-pan graph, and a time-tilt graph. In the first embodiment, an embodiment of controlling only pan and tilt has been described, but the configuration is not limited to this, and zoom may also be controlled.

### Second Embodiment

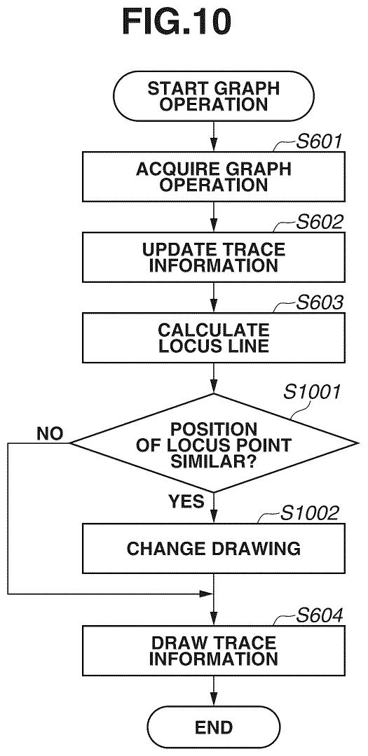

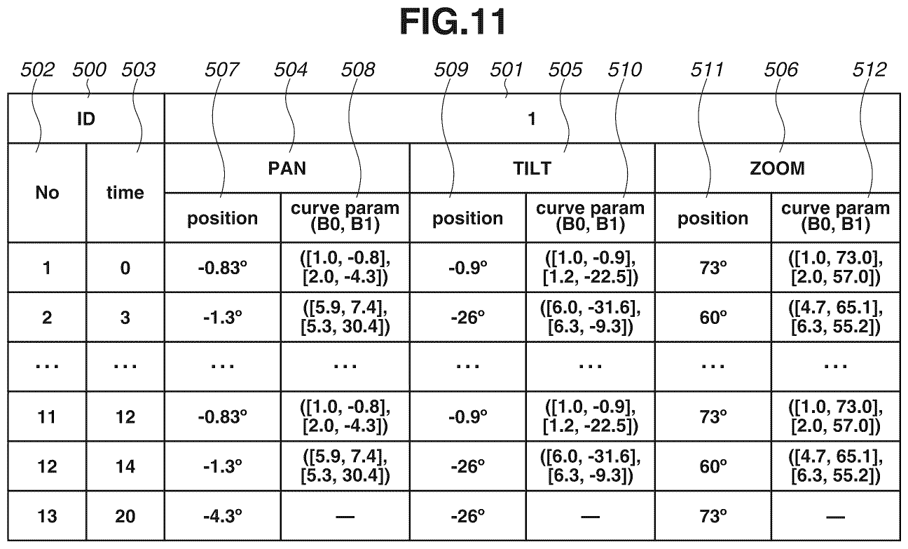

In the first embodiment, an example in which, when an instruction to create or edit trace information is received on a predetermined graph, a designated change in trace information is simultaneously displayed in a pan-tilt graph, a time-pan graph, and a time-tilt graph has been described. In the second embodiment, furthermore, the control of the trace information drawing unit 227 that is to be performed in a case where a locus line overlaps on the pan-tilt graph 410 will be described with reference to FIGS. 10 and 11.

For example, in the case of tracing bicycle race, a track event, or the like, loci of specific pan and tilt are repeated when a trace is reproduced in some situations. Furthermore, in one embodiment, when repeatedly tracing the same locus, in some cases, the movement between locus points is desired to be speeded up only for a specific operation.

When such trace information is created and edited, in the control according to the first embodiment, because locus lines appear to overlap on the pan-tilt graph 410, it is difficult for the user to execute creation and editing. In view of the foregoing, in the embodiment, a portion where locus lines overlap is detected, and the trace information drawing unit 227 changes the drawing of the overlapping portion.

Because the control in steps S601 to S604 is similar to that in FIG. 6, the description will be omitted.

In step S1001, the trace information drawing unit 227 determines whether to change drawing, with reference to the trace information updated in step S602. In FIG. 11, pan values, tilt values, and zoom values of a locus point number 1 and a locus point number 11 are similar. Furthermore, pan values, tilt values, and zoom values of a locus point number 2 and the locus point number 12 are similar. In the embodiment, in a case where pan values and tilt values of locus points match within a preset range, it is determined that the locus points match. Furthermore, in a case where a plurality of consecutive locus points matches, the trace information drawing unit 227 determines to change the drawing of a locus line between determined control points. In a case where it is determined in step S1001 that locus points match (YES in step S1001), the processing proceeds to step S1002. In a case where it is determined in step S1001 that locus points do not match (NO in step S1001), the processing proceeds to step S604. At this time, a range within which locus points are determined to match, and the number of a plurality of consecutive locus points may be set by the user, or may be determined based on a default setting. In addition, a parameter indicating a determination degree may be selected by the user, and the trace information drawing unit 227 may make determination based on the selection made by the user.

In step S1002, the trace information drawing unit 227 performs control in such a manner as to change the drawing of trace information based on the locus line created in step S603, and a determination result obtained in step S1001, and the processing proceeds to step S604.

At this time, in one embodiment, the trace information drawing unit 227 may perform control in such a manner as to change the drawing of only the pan-tilt graph 410, or may perform control in such a manner as to change the drawing of the same locus line range in the time-pan graph 420 and the time-tilt graph 430.

A drawing change example includes changing the color of a locus line including locus points in a related range, but the drawing change is not limited to this. For example, display may be performed by varying the shapes of markers of two points previous and next to locus points that are determined to match, or varying the style (dotted line, broken line) of a locus line, or the like.

In addition, change may be made in such a manner that an overlapping part becomes easy to view, by changing the transparency of a locus point or a locus line.

As described above, in the embodiment, a portion where locus lines overlap is detected, and the trace information drawing unit 227 changes the drawing of the overlapping portion, whereby the user can edit a trace while identifying trace information about a portion to be edited.

### Third Embodiment

In the first embodiment, an example in which, when an instruction to create or edit trace information is received on a predetermined graph, a designated change in trace information is simultaneously displayed in a pan-tilt graph, a time-pan graph, and a time-tilt graph has been described. In the third embodiment, furthermore, processing of displaying a captured image when editing of created trace information on a GUI is performed will be described.

For example, when trace information is corrected, a captured image to be acquired at a corrected pan, tile, or zoom position cannot be checked.

In view of the foregoing, in the embodiment, furthermore, it is possible to edit trace information while checking a captured image.

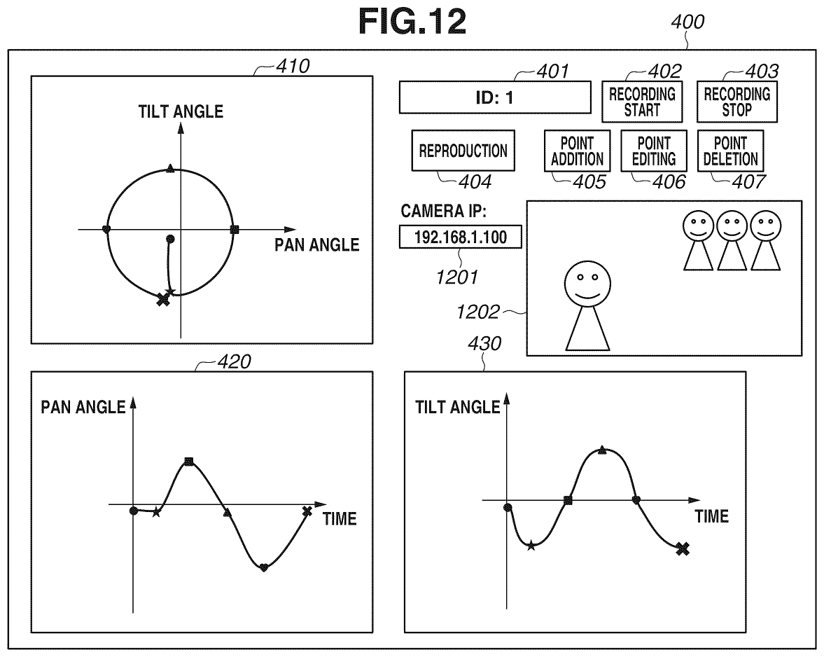

In the third embodiment, processing of driving an imaging apparatus when the editing of a trace is performed on a GUI will be described. Hereinafter, processing to be executed by the information processing apparatus 200 according to the third embodiment will be described with reference to FIGS. 12, 13, and 14.

FIG. 12 illustrates an example of a GUI to be displayed on the display unit 201 of the information processing apparatus 200. The GUI illustrated in FIG. 12 includes a camera address input unit 1201 and a camera image display unit 1202 in addition to the GUI components displayed on the display unit 201 illustrated in FIG. 4.

The camera address input unit 1201 is an interface for inputting an internet protocol (IP) address of a camera targeted by the camera information acquisition unit 220, the image acquisition unit 221, and the PTZ control unit 222.

If the IP address is input, an image acquired from the camera is displayed in the camera image display unit 1202 by the image acquisition unit 221. In the embodiment, an IP address is input, but the configuration is not limited to this. For example, a connected imaging apparatus may be selected from a drop-down list.

The camera image display unit 1202 is a region for displaying an image from the imaging apparatus 100 that has been acquired by the image acquisition unit 221 based on the IP address input to the camera address input unit 1201. In the embodiment, the information processing apparatus 200 continues to display a captured image of the imaging apparatus 100 on the display unit 201 while being connected to the imaging apparatus 100, but the configuration is not limited to this. For example, the information processing apparatus 200 may display a captured image in a case where the user performs a user operation of issuing an image display request. In addition, the information processing apparatus 200 may display a captured image after controlling the pan value, the tilt value, and the zoom value to be a pan value, a tilt value, and a zoom value that correspond to a locus point to be edited and added. That is, the information processing apparatus 200 may display a captured image with a pan value, a tilt value, and a zoom value that correspond to the locus point, without displaying an image during being driven, on the display unit 201.

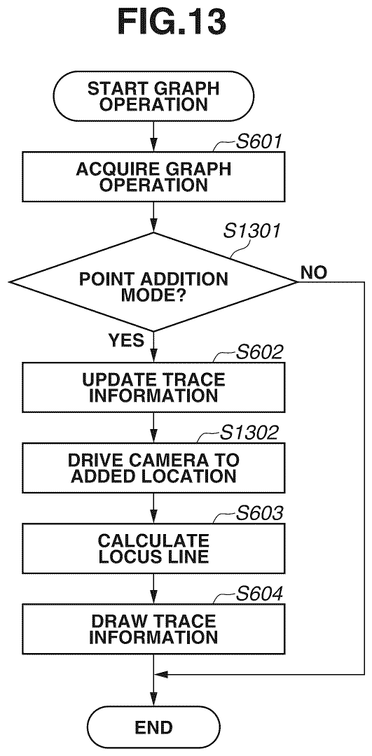

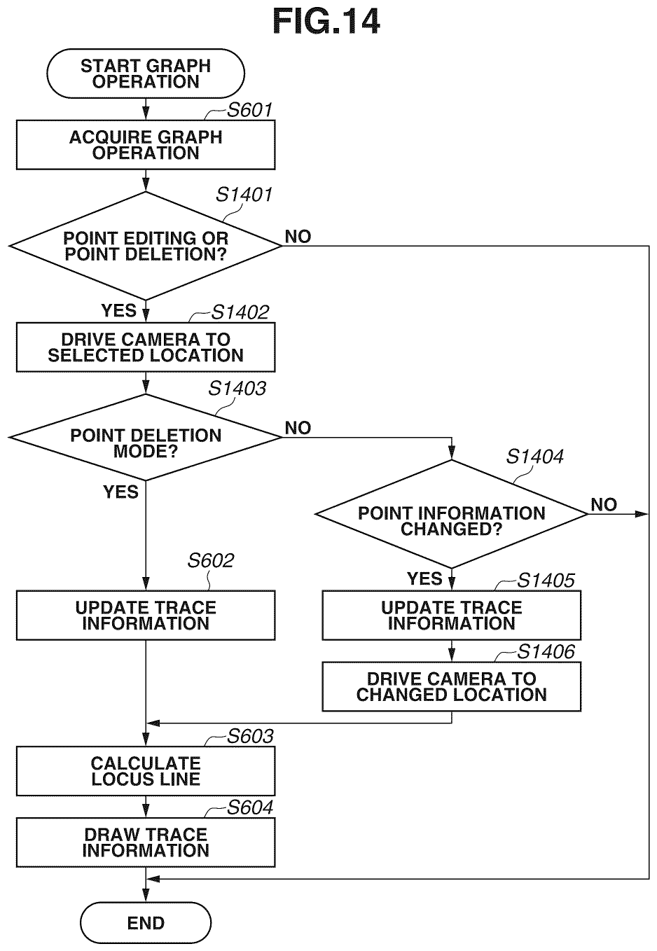

FIGS. 13 and 14 are flowcharts each illustrating a flow of processing of editing (or creating) trace information in any graph of the pan-tilt graph 410, the time-pan graph 420, and the time-tilt graph 430 displayed on the display unit 201. FIG. 13 is a flowchart illustrating a flow of control to be executed when a new locus point is added to trace information when trace information is created or edited. In addition, FIG. 14 is a flowchart illustrating a flow of control to be executed when information regarding a locus point already registered in trace information is edited in trace editing. The processing in this flowchart starts by the user operating a GUI displayed on the display unit 201, via the input unit 202, and ends by trace information being updated by the user.

First of all, processing to be executed when a new locus point is added to trace information will be described with reference to the flowchart in FIG. 13.

Because the configuration and content of the processing in step S601 are similar to those of the processing described with reference to FIG. 6, the description will be omitted.

In step S1301, the user request acquisition unit 223 determines whether the acquired request information includes “point addition”. In the embodiment, in a GUI illustrated in FIG. 12, in a case where the user performs a user operation via the input unit 202 when the point addition button 405 is in the pressed state, it is determined that the acquired request information includes “point addition”, but the configuration is not limited to this, and it is sufficient that “point addition” is designated by a user operation. Examples include a case where “point addition” is designated by a voice command, a case where “point addition” is designated using a gesture recognition system, a case where a specific swipe operation is performed on a touch screen, a case where a specific shortcut key is pressed from a keyboard, a case where “point addition” is selected from a right click menu of a mouse, a case where a specific icon of a mobile application is tapped, and the like. In a case where the user request acquisition unit 223 determines that the acquired request information includes “point addition”, the processing proceeds to step S602, and in a case where it is determined that the acquired request information does not include “point addition”, the trace information is updated, and the processing in this flowchart ends.

Because the configuration and content of the processing in step S602 are similar to those of the processing described with reference to FIG. 6, the description will be omitted.

In step S1302, the PTZ control unit 222 converts information regarding the locus point acquired in step S601, into control information for driving the imaging apparatus 100, and outputs the control information to the imaging apparatus 100. Here, the control information for driving the imaging apparatus 100 includes information regarding pan, tilt, and zoom target positions, drive time and drive speed information, and the like, for example. With this configuration, a camera image shown by the imaging apparatus 100 at the added locus point is displayed in the camera image display unit 1202.

Because the configuration and content of the processing in steps S603 and S604 are similar to those of the processing described with reference to FIG. 6, the description will be omitted.

As described above, it is possible to drive the imaging apparatus 100 to PTZ positions designated when an instruction to perform point addition is received from among editing units of a trace on a GUI.

Subsequently, processing to be executed when information regarding a locus point already-registered in trace information is edited will be described with reference to a flowchart in FIG. 14. The processing in this flowchart starts by the user operating a GUI displayed on the display unit 201, via the input unit 202, and ends by trace information being updated by the user.

Since the configuration and content of the processing in step S601 are similar to those of the processing described with reference to FIG. 6, the description will be omitted.

In step S1401, the user request acquisition unit 223 determines whether the acquired request information includes “point editing” or “point deletion”. In the embodiment, in a case where the user performs a user operation via the input unit 202 when the point editing button 406 is in the pressed state in the GUI illustrated in FIG. 12, it is determined that the acquired request information includes “point editing”, but the configuration is not limited to this. It is sufficient that “point editing” is designated by a user operation. Examples include a case where “point editing” is designated by a voice command, a case where “point editing” is designated using a gesture recognition system, and a case where a specific swipe operation is performed on a touch screen, a case where a specific shortcut key is pressed from a keyboard, a case where “point editing” is selected from a right click menu of a mouse, a case where a specific icon of a mobile application is tapped, and the like.

Similarly, in the embodiment, in a case where the user performs a user operation via the input unit 202 when the point deletion button 407 is in the pressed state in the GUI illustrated in FIG. 12, it is determined that the acquired request information includes “point deletion”, but the configuration is not limited to this. It is sufficient that “point deletion” is designated by a user operation. In a case where the user request acquisition unit 223 determines that the acquired request information includes “point editing” or “point deletion” (YES in step S1401), the processing proceeds to step S1402. In addition, in a case where it is determined that the acquired request information does not include “point editing” or “point deletion” (NO in step S1401), the trace information is updated, and the processing in this flowchart ends.

In step S1402, the PTZ control unit 222 converts information regarding at least any of a pan value, a tilt value, and a zoom value that correspond to the user operation acquired in step S601, into control information for driving the imaging apparatus 100, and outputs the control information to the imaging apparatus 100. Here, the control information for driving the imaging apparatus 100 includes position information about pan, tilt, and zoom, drive time and drive speed information, and the like, for example. With this configuration, a camera image shown by the imaging apparatus 100 at the designated locus point is displayed in the camera image display unit 1202. In step S1402, information regarding at least any of a pan value, a tilt value, and a zoom value designated by the user is converted into control information for driving the imaging apparatus 100, the control information is output to the imaging apparatus 100, and then, the processing proceeds to step S1403.

In step S1403, the user request acquisition unit 223 determines whether the acquired request information includes “point deletion”. Since a determination method is similar to the determination method used in step S1401, the description will be omitted. In a case where the user request acquisition unit 223 determines that the acquired request information includes “point deletion” (YES in step S1403), the processing proceeds to step S602, and in a case where the user request acquisition unit 223 determines that the acquired request information does not include “point deletion” (NO in step S1403), the processing proceeds to step S1404.

In step S1404, the trace editing unit 224 determines whether an operation performed by the user is editing of trace information. In a case where an instruction to change the position of a locus point or a control point is issued by an operation such as dragging (YES in step S1404), PTZ positions of the imaging apparatus 100 that correspond to the position of the edited locus point or control point are output to the PTZ control unit 222, and the processing proceeds to step S1405. In addition, in a case where the editing of trace information unrelated to the PTZ positions of the imaging apparatus 100, such as the editing of an elapsed time or the editing of white balance, is performed, the PTZ positions need not be output to the PTZ control unit 222. In a case where the trace editing unit 224 determines that an operation performed by the user is editing of trace information (YES in step S1404), the processing proceeds to step S1405. In a case where it is determined that an operation performed by the user is not editing of trace information (NO in step S1404) (for example, a case where point addition or only the checking of a camera image is performed by driving the imaging apparatus 100 to a position corresponding to a position designated in a graph, or the like is considered), the processing in the flowchart ends. At this time, in a case where trace information has not been edited during a predetermined time from when the graph operation has been acquired in step S601, it may be determined that an operation performed by the user is not editing of trace information. In addition, in a case where trace information has not been edited during a predetermined time after a control command is output to the imaging apparatus 100 in step S1402, it may be determined that an operation performed by the user is not editing of trace information.

Because the configuration and content of the processing in step S1405 are similar to those of the processing described with reference to step S602 in FIG. 6, the description will be omitted. In step S1405, the trace editing unit 224 updates trace information in accordance with the input graph information and request information, and then the processing proceeds to step S1406.

In step S1406, the PTZ control unit 222 transmits a control command to the imaging apparatus 100 using control information input by the trace editing unit 224. Here, the control information for driving the imaging apparatus 100 includes information regarding pan, tilt, and zoom target positions, an elapsed time, drive speed information, and the like, for example. With this configuration, a camera image shown by the imaging apparatus 100 at the added locus point is displayed in the camera image display unit 1202. At this time, in a case where trace information editing determined in step S1404 is the editing of trace information unrelated to the PTZ positions of the imaging apparatus 100, such as the editing of an elapsed time or the editing of white balance, the processing in this step need not be executed.

Since the configuration and content of the processing in steps S603 and S604 are similar to those of the processing described with reference to FIG. 6, the description will be omitted.

As described above, it is possible to drive the imaging apparatus 100 to PTZ positions designated when an instruction to edit a trace from a GUI is received. In the second embodiment, an embodiment of controlling only pan and tilt has been described, but the configuration is not limited to this, and zoom may be controlled as well.

In step S1402 or S1406, when the driving of the imaging apparatus 100 ends, display may be performed on a GUI to be displayed on the display unit 201 in such a manner that the user can recognize that the driving has ended (has been completed), and a target position has been reached. Examples include a method of displaying the color or the like of the reached locus point, in a superimposed manner as the color of a frame of the camera image display unit 1202. In addition, an image acquired by the image acquisition unit 221 when the driving of the imaging apparatus 100 ends may be stored into the storage unit 203 in association with a locus point, stored images may be displayed as a list, or an image stored when a locus point is selected may be displayed.

In addition, in a case where the user designates PTZ positions at which the imaging apparatus 100 cannot be driven, in step S1402 or S1406, trace information and graph display may be updated by changing the PTZ positions to positions at which the imaging apparatus 100 can be driven. For example, in a case where a part of a locus line contacts the edge of a control range of the imaging apparatus 100 when the change of the positions of pan and tilt axis components of a control point is performed, a graph is drawn in accordance with the actual movement of the imaging apparatus 100.

### Fourth Embodiment

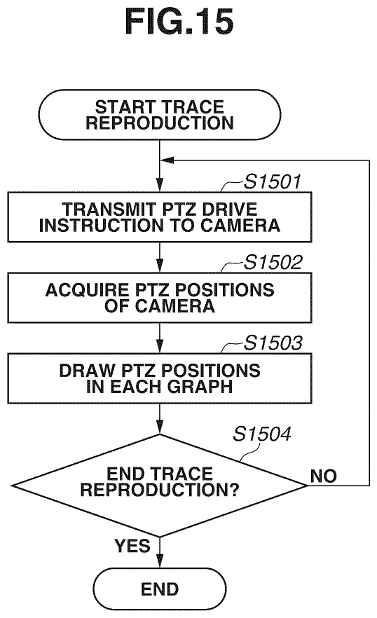

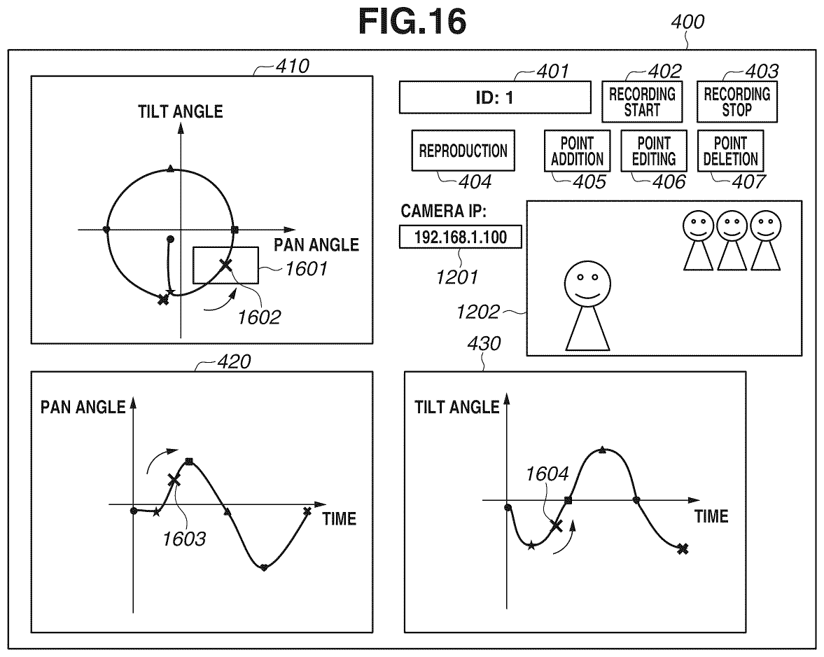

In the first embodiment, an example in which, when an instruction to create or edit trace information is received on a predetermined graph, a designated change in trace information is simultaneously displayed in a pan-tilt graph, a time-pan graph, and a time-tilt graph has been described. In the fourth embodiment, furthermore, processing of displaying a mark indicating the current PTZ positions of the imaging apparatus 100, in each graph when the reproduction of trace information created on a GUI is performed will be described. Hereinafter, processing to be executed by the information processing apparatus 200 according to the fourth embodiment will be described with reference to FIGS. 15 and 16.

For example, in a case where trace information is reproduced, a location desired to be corrected is sometimes identified while checking a captured image.

In this manner, when trace information is reproduced, in the control according to the first embodiment, it is difficult to recognize a portion being reproduced, in a series of pieces of trace information. In view of the foregoing, in the embodiment, the current PTZ positions of the imaging apparatus 100 are displayed in each graph in an identifiable manner at the time of trace reproduction.

By displaying pan, tilt, and zoom positions of the imaging apparatus 100 on a graph indicating the movement of the imaging apparatus 100 as described above, it becomes easier to edit trace information.

FIG. 15 is a flowchart illustrating a flow of processing to be executed by the system control unit 204 when a trace created on a graph displayed on the display unit 201 is reproduced. The processing in this flowchart is started by the user pressing the reproduction button 404 on a GUI displayed on the display unit 201, via the input unit 202, and ends by trace reproduction ending or a trace stop instruction being input by the user. FIG. 16 illustrates a display example of a GUI to be displayed on the display unit 201 when the processing is performed.

In step S1501, the trace reproduction unit 225 transmits a PTZ drive instruction to the imaging apparatus 100 by receiving a trace reproduction request input from the user request acquisition unit 223, reading out trace information stored in the storage unit 203, and transmitting a PTZ drive instruction to the PTZ control unit 222.

In step S1502, the camera information acquisition unit 220 acquires the current PTZ positions of the imaging apparatus 100, and outputs the current PTZ positions to the trace information drawing unit 227.

In step S1503, the trace information drawing unit 227 draws the current PTZ positions of the imaging apparatus 100 that have been input from the camera information acquisition unit 220. Furthermore, the trace information drawing unit 227 draws a marker indicating the PTZ positions of the imaging apparatus 100 during trace reproduction, based on an elapsed time from a trace reproduction start input from the trace reproduction unit 225. That is, the trace information drawing unit 227 performs control in such a manner as to display markers in three graphs corresponding to the pan-tilt graph 410, the time-pan graph 420, and the time-tilt graph 430 displayed on the display unit 201. At this time, in the pan-tilt graph 410, a rectangle (rectangle 1601 in FIG. 16) corresponding to a current zoom size that is based on a zoom value acquired in step S1502 is displayed together. At this time, in a case where zooming-in is performed during the reproduction of trace information, a rectangle size becomes smaller in accordance with the zooming-in. Similarly, if zooming-out is performed, a rectangle size becomes larger in accordance with the zooming-out. In this manner, by displaying a rectangle size during the reproduction of trace information, it becomes easier for the user to recognize a zoom value and execute editing.

In the GUI example illustrated in FIG. 16, a marker 1602 indicating pan and tilt angles is displayed in the pan-tilt graph 410, the time-pan graph 420, and the time-tilt graph 430. In addition, a marker 1603 indicating a time from a reproduction start, and a pan angle is displayed, and a marker 1604 indicating a time from a reproduction start, and a tilt angle is displayed. In addition to these, the rectangle 1601 corresponding to the current zoom size is also displayed on the pan-tilt graph 410.

In step S1504, it is determined whether trace reproduction executed by the information processing apparatus 200 has ended.

In a case where a request for “reproduction stop” is input by the user request acquisition unit 223, or in a case where trace reproduction has ended up to the trailing end of trace information (YES in step S1504), the processing in this flowchart ends. In other cases (NO in step S1504), the processing returns to step S1501.

As described above, when the reproduction of a trace created on a GUI is performed, marks indicating the current PTZ positions of the imaging apparatus 100 can be displayed in each graph.

When the information processing apparatus 200 reproduces a trace, a location where reproduction is being performed may be displayed in an easy-to-understand manner, by changing the color of a frame of the camera image display unit 1202 displayed on the display unit 201, in accordance with the color of a locus line in a section in which trace information is being reproduced. In addition, when passage of a locus point designated by the user occurs during trace reproduction, locus point passage may be displayed in a highlighted manner by blinking the frame of the camera image display unit 1202 displayed on the display unit 201, or the like.

In addition, a plot button is prepared on a GUI displayed on the display unit 201, and in a case where the plot button is pressed during the trace reproduction of the information processing apparatus 200, pan/tilt/zoom position information obtained at the time is stored. Furthermore, the user may be enabled to store a point of interest during trace reproduction, by drawing the location on the graphs corresponding to the pan-tilt graph 410, the time-pan graph 420, and the time-tilt graph 430. At this time, an image captured by the imaging apparatus 100 that has been acquired by the image acquisition unit 221 may be stored together.

In addition, in the embodiment, the rectangle 1601 corresponding to the zoom value may be displayed also during the editing of trace information. By the user displaying pan, tilt, and zoom positions of the imaging apparatus 100 as described above, on a graph indicating the movement of the imaging apparatus 100, by dragging the rectangle 1601, or designating a rectangle size, it becomes easier to edit trace information.

In the embodiment, when trace information is reproduced, the current PTZ positions of the imaging apparatus 100 are acquired from the imaging apparatus 100. Furthermore, the marker 1602 indicating pan and tilt angles is drawn in the pan-tilt graph 410, the time-pan graph 420, and the time-tilt graph 430, but the configuration is not limited to this. For example, while the imaging apparatus 100 and the information processing apparatus 200 are connected in such a manner that communication can be performed, the current position of the imaging apparatus 100 is acquired at predetermined intervals. Furthermore, the marker 1603 indicating pan and tilt angles may be drawn in the pan-tilt graph 410, the time-pan graph 420, and the time-tilt graph 430. In this case, it is easy to visually recognize how far the current PTZ positions and the PTZ positions indicated by trace information are separated from each other, and it is easy to be conscious of a position to which a trace is to be edited in order to obtain an arbitrary captured image during trace reproduction. In addition, in a case where trace reproduction or editing enters an executable state, the current position of the imaging apparatus 100 is acquired. Furthermore, the marker 1604 indicating pan and tilt angles may be drawn in the pan-tilt graph 410, the time-pan graph 420, and the time-tilt graph 430. In this case, by drawing the current PTZ positions before trace reproduction even in a case where a communication delay occurs, when trace reproduction is performed, it is possible to promptly visually recognize a position to be edited.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-218471, filed Dec. 13, 2024, which is hereby incorporated by reference herein in its entirety.

What is claimed is:

1. A processing apparatus comprising:
at least one processor; and
at least one memory coupled to the at least one processor storing instructions that, when executed by the at least one processor, cause the at least one processor to function as:
an acquisition unit configured to acquire a captured image from an imaging apparatus that can be driven to pan and tilt;
a display control unit configured to perform control in such a manner as to display a first region for displaying transition information about a pan angle or a tilt angle of the imaging apparatus, a second region for displaying at least one or more of information regarding a temporal transition of a pan angle and a temporal transition of a tilt angle, and a third region for displaying the acquired captured image;
an editing unit configured to edit information displayed in the first region and the second region; and
a control unit configured to control a pan angle or a tilt angle of the imaging apparatus,
wherein the control unit performs control in such a manner as to drive the imaging apparatus to a pan angle or a tilt angle designated by a user, in the first region or the second region.

2. The processing apparatus according to claim 1, wherein, in a case where the control unit can control a pan angle or a tilt angle, the display control unit controls the acquired captured image, to be displayed in the third region.

3. The processing apparatus according to claim 1, wherein, while the imaging apparatus is driven, the display control unit controls the acquired captured image, to be displayed in the third region.

4. The processing apparatus according to claim 1,
wherein the imaging apparatus can be driven to zoom,
wherein the control unit controls a zoom position, and
wherein the control unit performs control in such a manner as to drive the imaging apparatus to a pan angle, a tilt angle, and a zoom position designated by a user, in the first region or the second region.

5. The processing apparatus according to claim 1, wherein the transition information about the pan angle or the tilt angle, and the temporal transition of the pan angle or the temporal transition of the tilt angle correspond to trace information storing a transition of a plurality of operations on the imaging apparatus.

6. The processing apparatus according to claim 1,
wherein the first region is a two-dimensional graph indicating pan on a first axis, and indicating tilt on a second axis, and the second region includes at least one of a two-dimensional graph indicating time on a first axis, and indicating pan on a second axis, and a two-dimensional graph indicating time on a first axis, and indicating tilt on a second axis, and
wherein the trace information displays control information about the imaging apparatus using a locus line.

7. The processing apparatus according to claim 1, wherein the editing unit adds at least one locus point of a plurality of locus points included in the locus line, deletes the locus point, changes a pan angle or a tilt angle corresponding to the locus point, changes a target reach time of the locus point, and changes the locus line.

8. The processing apparatus according to claim 7,
wherein the locus point includes identification information that enables identification of each locus point, and
wherein the identification information includes target positions of a pan angle and a tilt angle, and the target reach time.

9. The processing apparatus according to claim 7, further comprising a calculation unit configured to calculate a locus line based on the locus point,
wherein the control unit controls the imaging apparatus based on the calculated locus line.

10. The processing apparatus according to claim 9,
wherein, in a case where a locus point is added by the editing unit to a locus line displayed in the first region, a time obtained by adding a predetermined time to a time of a locus point existing immediately before the locus point is recorded as identification information about the locus point, and in a case where a locus point is added to a locus line displayed in the second region, a predetermined pan or tilt value is recorded as identification information about the locus point, and
wherein the control unit controls the imaging apparatus in accordance with a pan angle or tilt angle of the added locus point.

11. The processing apparatus according to claim 9, wherein, in a case where the editing unit edits identification information about a locus point of the locus line, the control unit controls the imaging apparatus in accordance with a pan angle or a tilt angle that is based on the edited identification information.

12. The processing apparatus according to claim 9, wherein, in a case where a predetermined position in the first region or the second region is designated, the control unit controls the imaging apparatus in accordance with a pan angle or a tilt angle corresponding to the predetermined position.

13. The processing apparatus according to claim 10, further comprising:
an information acquisition unit configured to acquire control information from the imaging apparatus; and
a storage unit configured to store, in a case where the control unit controls the imaging apparatus, and information indicating completion of control is acquired from the imaging apparatus, the acquired captured image, in association with a locus point.

14. The processing apparatus according to claim 13, wherein, in a case where a locus point is selected by the editing unit, the display control unit controls a captured image stored in association with the locus point, to be displayed.

15. A method of controlling a processing apparatus, the method comprising:
acquiring a captured image from an imaging apparatus that can be driven to pan and tilt;
performing control in such a manner as to display a first region for displaying transition information about a pan angle or a tilt angle of the imaging apparatus, a second region for displaying at least one or more of information regarding a temporal transition of a pan angle and a temporal transition of a tilt angle, and a third region for displaying a captured image acquired in the acquiring;
editing information displayed in the first region and the second region; and
controlling a pan angle or a tilt angle of the imaging apparatus,
wherein the controlling performs control in such a manner as to drive the imaging apparatus to a pan angle or a tilt angle designated by a user, in the first region or the second region.

16. The method according to claim 15, wherein, in a case where the controlling can control a pan angle or a tilt angle, the performing controls the acquired captured image, to be displayed in the third region.

17. The method according to claim 15, wherein, while the imaging apparatus is driven, the performing controls the acquired captured image, to be displayed in the third region.

18. A non-transitory storage medium storing a program of a processing apparatus causing a computer to perform a method comprising:
acquiring a captured image from an imaging apparatus that can be driven to pan and tilt;
performing control in such a manner as to display a first region for displaying transition information about a pan angle or a tilt angle of the imaging apparatus, a second region for displaying at least one or more of information regarding a temporal transition of a pan angle and a temporal transition of a tilt angle, and a third region for displaying a captured image acquired in the acquiring;
editing information displayed in the first region and the second region; and
controlling a pan angle or a tilt angle of the imaging apparatus,
wherein the controlling performs control in such a manner as to drive the imaging apparatus to a pan angle or a tilt angle designated by a user, in the first region or the second region.

19. The non-transitory storage medium according to claim 18, wherein, in a case where the controlling can control a pan angle or a tilt angle, the performing controls the acquired captured image, to be displayed in the third region.

20. The non-transitory storage medium according to claim 18, wherein, while the imaging apparatus is driven, the performing controls the acquired captured image, to be displayed in the third region.
